(19) United States
(12) Patent Application Publication
(10) Pub. No.: US 2024/0033164 A1
(43) Pub. Date: Feb. 1, 2024

(54) SYSTEMS FOR CIRCULATORY-RELATED DISORDERS

(71) Applicant: INOVA LABS, INC. DBA MONTEREY HEALTH, San Diego, CA (US)

(72) Inventors: Dinesh Ramanan, Sydney (AU); Matthew Backler, Tauranga (NZ); Gaetano Caldarola, Bella Vista NSW (AU); Charles Andrew William Hartson, Sydney (AU); Luke Klinkenberg, Bella Vista NSW (AD); Blythe Rees-Jones, Papamoa (NZ); Francis Eric Saunders, San Diego, CA (US); Tzu-Chin Yu, Sydney (AU)

(21) Appl. No.: 18/272,288

(22) PCT Filed: Jan. 14, 2022
(86) PCT No.: PCT/US2022/012624

§ 371 Date: Jul. 13, 2023

Related U.S. Application Data
(60) Provisional application No. 63/138,176, filed on Jan. 15, 2021.

(51) Int. Cl. A61H 9/00

(52) U.S. Cl. CPC A61H 9/0092; A61H 2209/00; A61H 2201/1409; A61H 2201/5056; A61H 2201/165; A61H 2201/5007; A61H 2201/5046; A61H 2205/12; A61H 2201/1642; A61H 2201/169; A61H 2201/5002

(57) ABSTRACT

A compression garment for implementing circulatory-related disorder therapy includes a plurality of chambers. In some implementations, the compression garment further includes air supply tubes and tube guides for maintaining the air supply tubes on a predetermined pathway in or on the garment. In some implementations, the compression garment further includes three or more layers forming the macro-chambers and air supply channels for supplying air to the macro-chamber. In some implementations, the compression garment further includes a flexible foot chamber support assembly that allows bending around a periphery of a user's foot. In some implementations, the compression garment further includes chamber valves and a main air supply valve pneumatically connected to a central air supply line and configured to control the supply of pressurized air to at least two of the chamber valves.

### CROSS-REFERENCE TO RELATED APPLICATIONS

The present application claims priority to and the benefit of U.S. Provisional Patent Application No. 63/138,176, filed Jan. 15, 2021, entitled “SYSTEMS FOR CIRCULATORY-RELATED DISORDERS,” the disclosure of which is hereby incorporated by reference herein in its entirety.

### TECHNICAL FIELD

The present disclosure relates generally to systems for the treatment and/or amelioration of circulatory-related disorders, such as a disorder of the lymphatic system. In particular, the present disclosure relates to medical devices, and their components, such as for Lymphedema therapy, including compression garments, control apparatus, and system for implementing circulatory-related disorder therapy.

### BACKGROUND

The lymphatic system is crucial to keeping a body healthy. The system circulates lymph fluid throughout the body. This circulation collects bacteria, viruses, and waste products. The lymphatic system carries this fluid and the collected undesirable substances through the lymph vessels, to the lymph nodes. These wastes are then filtered out by lymphocytes existing in the lymph nodes. The filtered waste is then excreted from the body.

Lymphedema concerns swelling that may occur in the extremities, in particular, any of the arms, legs, feet, etc. The swelling of one or more limbs can result in significant physical and psychological morbidity. Lymphedema is typically caused by damage to, or removal of, lymph nodes such as in relation to a cancer therapy. The condition may result from a blockage in the lymphatic system, a part of the immune system. The blockage prevents lymph fluid from draining. Lymph fluid build-up leads to the swelling of the related extremity.

Thus, Lymphedema occurs when lymph vessels are unable to adequately drain lymph fluid, typically from an arm or leg. Lymphedema can be characterized as either primary or secondary. When it occurs independently from other conditions it is considered primary Lymphedema. Primary Lymphedema is thought to result from congenital malformation. When it is caused by another disease or condition, it is considered secondary Lymphedema. Secondary Lymphedema is more common than primary Lymphedema and typically results from damage to lymphatic vessels and/or lymph nodes.

Lymphedema is a chronic and incurable disease. If untreated, Lymphedema leads to serious and permanent consequences that are costly to treat. Many of the high-cost health consequences from Lymphedema might be prevented by early detection and access to appropriate remedial services. As there is no presently known cure for lymphedema, improvement in treating this and other circulatory-related conditions, such as, for example, deep vein thrombosis, chronic venous insufficiency, and restless leg syndrome, is desirable. The present disclosure is directed to solving these and other problems.

### SUMMARY

According to some implementations of the present disclosure, a compression garment for implementing circulatory-related disorder therapy includes one or more independently pressurizable macro-chambers. Each macro-chamber is configured to receive pressurized air. One or more air supply tubes are configured to supply pressurized air to a respective one of the one or more independently pressurized macro-chambers. One or more tube guides are configured to maintain a corresponding one of the one or more air supply tubes on a predetermined pathway in or on the garment. One or more valves are pneumatically connected to an air supply tube and to at least one of the one or more independently pressurized macro-chambers. The one or more valves are configured to supply pressurized air to one or more independently pressurizable macro-chambers. The one or more tube guides define predetermined pathways to or from one or more valves, or to or from one or more independently pressurized macro-chambers.

According to some implementations of the present disclosure, a compression garment for implementing circulatory-related disorder therapy includes an inner layer, an outer layer, and an intermediate layer positioned between the inner layer and the outer layer. One or more independently pressurizable macro-chambers are integrally formed between any two layers on the inner layer facing side of the intermediate layer. Each macro-chamber is configured to receive pressurized air. One or more air supply channels are integrally formed within the garment between any two layers on the outer layer facing side of the intermediate layer. The one or more air supply channels are configured to supply pressurized air to a respective one of the one or more independently pressurized macro-chambers. One or more valves are each pneumatically connected to an air supply channel and to one or more independently pressurizable macro-chambers. The one or more valves are configured to supply pressurized air to the one or more independently pressurizable macro-chambers.

According to some implementations of the present disclosure, a compression garment for circulatory-related disorder therapy includes a foot section configured to wrap at least partially around a user's foot. The compression garment comprises a plurality of independently pressurizable chambers including at least one foot-section chamber configured to receive pressurized air. A foot chamber support assembly is configured to support the at least one foot-section chamber at a user's foot. At least a portion of the foot chamber support assembly is flexible to allow bending around a periphery of the user's foot during use, and thereby aid the foot chamber support assembly to conform to the user's foot.

According to some implementations of the present disclosure, a compression garment for circulatory-related disorder therapy includes a plurality of chambers, a plurality of chamber valves, and a main air supply valve. The plurality of chamber valves are each configured to supply pressurized air to a corresponding chamber such that the pressurized air can be delivered to each of the plurality of chambers. The main air supply valve is pneumatically connected to a central air supply line and configured to control the supply of pressurised air to at least two of the plurality of chamber valves. The main air supply valve is located on or in the garment.

According to some implementations of the present disclosure, a circulatory-related disorder therapy system comprises any one of the compression garments configured to be pressurized by a compression pressure generator. A controller, including one or more processors, is configured to control operation of the compression pressure generator in a therapy process to generate pneumatic pressure in the plurality of chambers of the compression garment during a therapy period.

The above summary is not intended to represent each implementation or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The present technology is illustrated by way of example, and not by way of limitation, in the figures of the accompanying drawings, in which like reference numerals refer to similar elements including:

FIG. 1 is a perspective view of a compression therapy system for compression therapy including a compression pressure generator (CPG device) with a link to a compression garment and/or an optional control device, according to some implementations of the present disclosure.

FIG. 2 is a block diagram of a compression therapy system including the components of the system of FIG. 1, according to some implementations of the present disclosure.

FIGS. 3A to 3C are block diagrams of compression therapy systems including components of the compression therapy systems of FIGS. 1 and 2 with a valve spine arrangement, according to some implementations of the present disclosure.

FIGS. 4A and 4B are block diagrams of exemplary valve spine arrangements implemented in a compression garment, according to some implementations of the present disclosure.

FIG. 5 is a top view of an exemplary valve spine arrangement based on valve spine block diagram of FIG. 4A, according to some implementations of the present disclosure.

FIG. 6 is a partially exploded perspective view of an exemplary valve spine arrangement similar to the valve spine arrangement of FIG. 5, according to some implementations of the present disclosure.

FIG. 7 is a top partial view of an exemplary valve spine arrangement similar to the valve spine arrangement of FIG. 6, according to some implementations of the present disclosure.

FIG. 8 is a graph depicting valve timing for an exemplary implementation of a compression therapy mode associated with a valve spine arrangement similar to the valve spine arrangement of FIGS. 4A, 4B, and 7, according to some implementations of the present disclosure.

FIGS. 9A to 9C are exemplary exploded perspective and cross-sectional schematic views through a compression garment including air supply channels formed between layers of a three-layer compression garment, according to some implementations of the present disclosure.

FIGS. 10A, 10B-1 and 10B-2 are exemplary exploded perspective and cross-sectional schematic views of a compression garment including transverse cross-sections of air supply channels formed between layers of a four-layer compression garment, according to some implementations of the present disclosure.

FIGS. 10C and 10D are partial exemplary cross-sectional schematic views of a compression garment including longitudinal cross-sections along air supply channels formed between layers of a four-layer compression garment, according to some implementations of the present disclosure.

FIG. 11 is a top view of a compression garment including tube guides including a cross-sectional view through a transverse cross-section of the tube guides, according to some implementations of the present disclosure.

FIG. 12 is a perspective view of exemplary tube guides and air supply tubes for a compression garment, according to some implementation of the present disclosure.

FIG. 13 is a flattened top view of an exemplary leg and/or a partial foot compression garment including macro-chambers and micro-chambers within the macro-chambers, according to some implementations of the present disclosure.

FIG. 14 is a top view of an exemplary compression garment for a foot including the subdividing of a macro-chamber into micro-chamber, according to some implementation of the present disclosure.

FIGS. 15A and 15B are top and bottom views of a foot section of a compression garment that wraps at least partially around a user's foot during use, according to some implementations of the present disclosure.

FIG. 16A is a bottom perspective view of a foot chamber support assembly including a wrapping portion and a flexible sole coupled to the wrapping portion, according to some implementations of the present disclosure.

FIG. 16B is a top perspective view of the foot chamber support assembly of FIG. 16A, according to some implementations of the present disclosure.

FIG. 16C is a top perspective view of a compression garment for a leg including independently pressurizable chambers and a foot-section chamber, according to some implementations of the present disclosure.

While the present disclosure is susceptible to various modifications and alternative forms, specific implementations and embodiments thereof have been shown by way of example in the drawings and will herein be described in detail. It should be understood, however, that it is not intended to limit the present disclosure to the particular forms disclosed, but on the contrary, the present disclosure is to cover all modifications, equivalents, and alternatives falling within the spirit and scope of the present disclosure as defined by the appended claims

### DETAILED DESCRIPTION

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting. In particular, while the condition being monitored or treated is usually referred to below as Lymphedema, it is to be understood that the described technologies are also applicable to treatment and monitoring of other circulatory-related disorders.

Elements and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa. The word “including” means “including without limitation.” Moreover, words of approximation, such as “about,” “almost,” “substantially,” “approximately,” “generally,” and the like, can be used herein to mean “at,” “near,” or “nearly at,” or “within 3-5% of,” or “within acceptable manufacturing tolerances,” or any logical combination thereof, for example.

Compression garment devices and systems for circulatory therapy are described in U.S. patent application Ser. No. 16/849,932, published as U.S. Patent Application Publication No. 2020/0237607, U.S. application Ser. No. 16/428,512, filed May 31, 2019, published as U.S. Patent Application Publication No. 2020/0113773, and International Application No. PCT/US2019/055474, filed Oct. 9, 2019, published as WO 2020/077008, the disclosures of each of which are hereby incorporated by reference herein in their entireties.

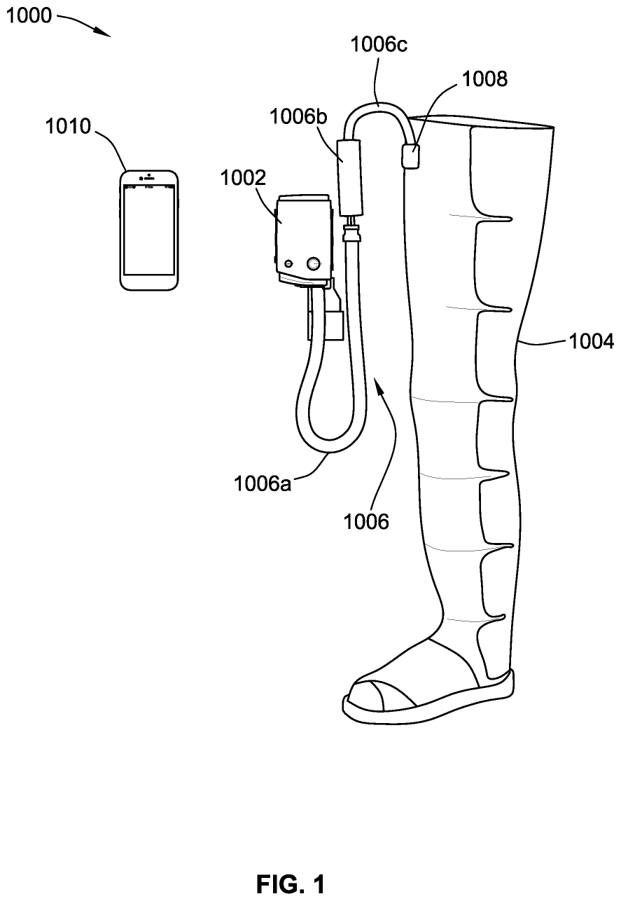

Referring to FIG. 1, a perspective view of a compression therapy system 1000 for compression therapy is depicted. The system 1000 includes a compression pressure generator (CPG) device 1002, such as the ResMed AirMini™ (as manufactured by ResMed Inc. headquartered in California), the Aria Free™ (as manufactured by Aria Health. headquartered in California), or a similar device, and a compression garment 1004. In some implementations, the CPG device 1002 may also be referred to as a flow generator, as it actually generates the air flow that creates the pressure in the garment. A link 1006, provides pneumatic and/or electrical coupling for control and/or operation of the compression garment 1004, and connects the CPG device 1002 and the compression garment 1004. The link 1006 may connect with a conduit and/or valve interface 1008, such as one that is either integrated with, or is separate from, the compression garment 1004. The compression therapy system 1000 optionally includes a control device 1010, such as a mobile phone, tablet, laptop or other computing or computer device, executing an application to provide for setting the operational parameters (e.g., mode, type of therapy, operational parameters (i.e. flow or pressure settings etc.) of the CPG device 1002 and/or monitoring operations and detected parameters of the CPG device 1002 and/or controlling/monitoring of various parameters of the compression garment 1004.

In some implementations, the link 1006 includes a separate pneumatic tube and electrical coupling that run in a common tube 1006a for control and operation of the compression garment 1004. In the illustrated embodiment, the combined pneumatic tube and electrical coupling 1006a connect to a valve control component 1006b that includes a printed circuit board assembly (PCBA) configured to issue commands for turning valves in the compression garment on and off. The valve control component 1006b is connected to a combined flexible PCBA and main air supply line 1006c to allow the electrical signals with the commands from the valve control component 1006b to be transmitted to a respective valve in the compression garment 1004. The flexible PCBA in the combined flexible PCBA and main air supply line 1006c includes separate control lines for each valve used to pressurize and depressurize the compression garment 1004. In some implementations, the valve control component 1006b may be integrated into the CPG device 1002.

In one example, the described arrangement allows a use of a CPG device 1002, such as the ResMed AirMini™, Aria Free™, or a similar device, by simply installing a respective software application and without the need to introduce any structural changes to the device. In this case any changes to the operational parameters of the garment are instructed by the CPG device 1002, which communicates with the intermediate (external) valve control component 1006b, which has a microcontroller that controls a series of switches to turn valves on and off. The valve control component is connected to the valves by means of a flexible PCBA 6080. In some implementations, a multi-core cable can be used as an alternative to the flexible PCBA 6080. In practice, the flexible PCBA 6080 can include various electronic components, such as one or more diodes for each valve, to minimise current spikes.

The flexible PCBA in the combined flexible PCBA and main air supply line 1006c includes separate control lines for each valve used to pressurize and depressurize the compression garment 1004. In some implementations, the CPG device 1002 may be modified and the valve control component 1006b may be integrated with CPG device 1002. Alternatively, the valve control component 1006b may be integrated with the garment itself.

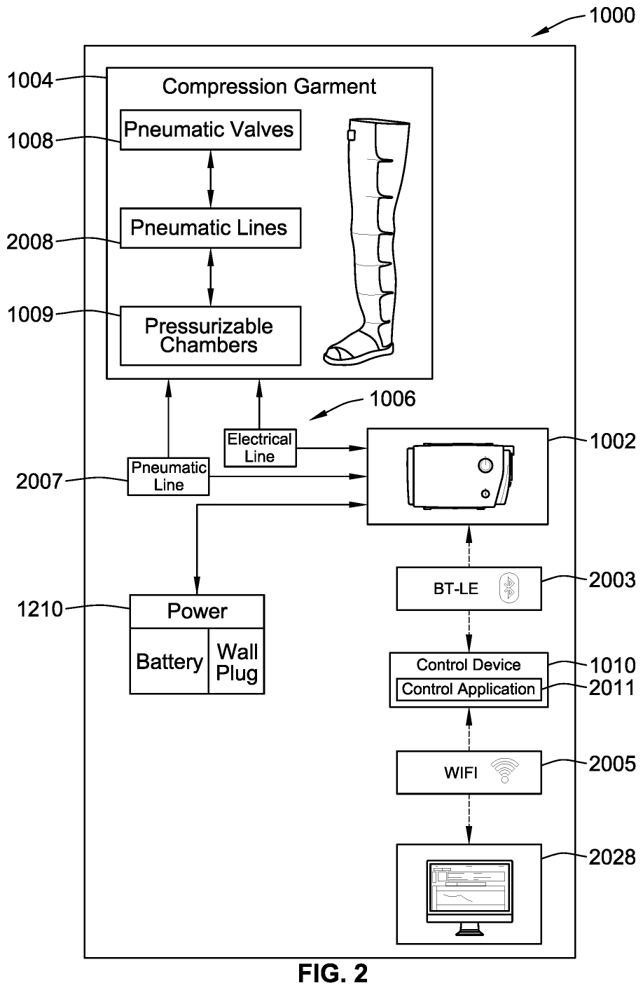

Referring to FIG. 2, various interactions of components of the system 1000 are shown. In some implementations, the system 1000 can include a portal system 2028, such as one with one or more servers, for managing a population of CPG devices. The CPG device 1002 conducts control device related communications 2003, such as wireless communications, with the control device 1010, running a control application 2011. Such communications may involve an exchange of data collected by the CPG device 1002, such as testing measurements and/or usage time, and sent to the control device 1010. Such communications may involve an exchange of control parameters for setting operations of the CPG device 1002, such as valve subset identifiers (zone) for controlling particular valves of the set of valves of the compression garment 1004, a pressure setting for the CPG device 1002, a therapy mode identifier, therapy times, a number of cycles etc. to the CPG device 1002. The wireless communications 2003 may employ a low energy wireless communications protocol such as Bluetooth LE or other.

The system 1000 can include a control application 2011, within the control device 1010, that can be used to control the control device related communications 2003, as well as be configured to provide various information (i.e. limb, pressure, and usage feedback information) to a user. The control application 2011 can serve as a virtual coach such as by employing an artificial intelligence chat program. The control application 2011 can serve as a social networking tool to other patients receiving similar care with a CPG device. The control application 2011 can provide information to the user in relation to troubleshooting operations with the system 1000. The control application 2011 can serve as a symptom tracker such as with input from the user and from the CPG device. The control application 2011 can permit customization (personalization) with respect to the parameters controlling the therapy pressure waveform provided with the compression garment and the CPG device. The control application 2011 can serve as an electronic store for ordering resupply components of the system (e.g., conduits, valve interfaces 1008, and compression garments). The control application 2011 can provide informative/educational messages about disease condition (e.g., lymphedema). The control application 2011 can provide user controls to start, stop and set up compression therapy sessions with the CPG device 1002 as well as run diagnostic processes with the CPG device 1002 and compression garment 1004. The control application 2011 can simplify use and setup workflow with the CPG device 1002.

The control device 1010 can be configured for portal related communications 2005, such as wireless communications (e.g., wireless protocol communications WiFi), with the portal system 2028. The portal system 2028 can receive, from the control device 1010, testing measurements, therapy parameters, and/or usage time, and may communicate to the control device 1010, parameters for setting operations of the CPG device 1002, such as valve subset identifiers (zone) for controlling particular valves of the set of valves of the compression garment 1004, a pressure setting for the CPG device 1002, a therapy mode protocol, therapy times, a number of cycles, etc. Such a portal system 2028 can be managed by a clinician organization to provide actionable insights to patient condition for a population of CPG devices and their users.

For example, a clinician may provide prescriptive parameters for use of the CPG device 1002 (e.g., therapy control parameters) that may in turn be communicated to a control device 1010 and/or a CPG device 1002. Such communications, such as in relation to receiving testing measurements from the CPG device 1002 via the control device 1010, can permit therapy customization, such as by setting the prescriptive parameters based on the testing measurements. The portal system 2028 may similarly be implemented for compliance management in relation to received usage information from the CPG device 1002. The portal system 2028 may then serve as an integrated part of electronic medical records for a patient's lymphedema therapy.

The CPG device 1002 communicates via link 1006 with a valve interface 1008 that, in some implementations, is on or in the compression garment 1004. The CPG device 1002 may generate electrical valve control signals on electric lines of a bus to the valve interface 1008 and receive electrical valve operation signals from the valves of the valve interface 1008 on the electric lines of the bus of the link 1006. The CPG device 1002 may also generate air flow such as a controlled pressure and/or flow of air to/from the valve interface 1008 via one or more pneumatic conduits 2007 of the link 1006. The valve interface 1008 may then selectively direct the pressure and/or flow to/from the pressurizable chambers 1009 of the garment 1004 via any of the pneumatic lines 2008 and the valve interface 1008. The valves of the interface 1008 and/or the pneumatic lines 2008 may be integrated with the compression garment 1004, as depicted in FIG. 2. In some implementations, the electrical line(s) of the link 1006 may be a part of a flexible PCBA. In some implementations, the electrical line(s) may be integrated with the pneumatic line 2007.

In some implementations, the CPG 1002 may have a compact and/or portable design to simplify use with a compression garment (e.g., compression garment 1004). The CPG device 1002 can include a start/stop button, a communications link button to aid in establishing a communications link (e.g., wireless communications) with the control device 1010, and an electrical interface for electrically coupling with an interface 1008 or valves of the garment 1004. The CPG device 1002 also includes a pneumatic interface (inlet/outlet) for pneumatic coupling with the compression garment 1004, such as via a set of valves.

In some implementations, the CPG device 1002 may have a programmable controller to provide operations for compression therapies described herein and diagnostic operations. Such therapies may be provided by control of a blower of the CPG device 1002 that may produce positive pressure and/or negative pressure operations via one or more pneumatic conduits coupled to the compression garment 1004. For example, the CPG device 1002 may be configured to generate varied positive pressure for compression up to a maximum of about 50 mmHg into one or more chambers of the compression garment 1004. Similarly, the CPG device 1002 may produce negative pressure, such as to evacuate one or more pneumatic chambers of the compression garment 1004. Such a generation of positive and/or negative pressure (e.g., sub-ambient pressure, vacuum, etc.) may be controlled to provide compression therapy, including massage therapy, with the compression garment 1004 in relation to a set of pneumatic chambers within the compression garment 1004 that are pneumatically coupled to the blower of the CPG device 1002, such as via one or more valves and/or hoses that may be implemented with the interface 1008 (FIG. 1).

In some implementations, the pneumatic chambers may be passively evacuated (depressurized or deflated) without the application of negative pressure to the pneumatic chambers. In such implementations, the pneumatic chambers may be selectively pneumatically coupled to atmosphere via one or more active exhaust valves. When pneumatically coupled to atmosphere via an actuated exhaust valve, a pneumatic chamber deflates to ambient pressure. Such implementations allow the use of CPG devices that do not generate negative pressure. An exhaust valve may be located on the CPG device 1002 itself. Alternatively, or additionally, one or more exhaust valves may be located in the interface 1008 or distributed over the compression garment 1004 itself. In the latter implementations, the CPG device 1002 may generate exhaust valve control signals on electric lines of a bus forming part of the link 1006 to actuate the one or more active exhaust valves.

In some implementations, the CPG may further include one or more input devices (e.g., buttons), a central controller, a therapy device controller, a therapy device (e.g., blower with impeller and motor), one or more optional protection circuits, memory, transducers, data communication interface and one or more output devices (e.g., lights, valve control). Electrical components in the CPG 1002 may be mounted on a single PCBA. In an alternative form, the CPG device 1002 may include more than one PCBA. The central controller of the CPG device 1002 is programmed to execute one or more compression mode control algorithms, and may include a detection module (e.g., sine wave generation control and evaluation).

As depicted in FIG. 2, the CPG device 1002 is connected to or may include an electrical power supply 1210, such as a battery power supply and/or AC main power supply converter (e.g., alternating current AC to direct current DC). The power supply 1210 supplies power to the other components of the CPG device 1002, such as, the input device, the central controller, the therapy device, and the output device, valves, etc. Such a power supply may provide a DC voltage, such as 24 volts. The power supply 1210 can be internal to the external housing of the CPG device 1002, such as in the case of a battery (e.g., a rechargeable battery). Alternatively, the power supply 1210 can be external of the external housing of the CPG device 1002. The internal or external power supply may optionally include a converter such as to provide a DC voltage converted from an AC supply (e.g., a main supply).

The CPG device 1002 can include a flow or pressure device for producing a flow of air at positive pressure using a controllable blower. For example, the blower may include a brushless DC electric motor with one or more impellers housed in a volute. The blower is capable of delivering a supply of air and/or drawing (e.g., evacuating) a supply of air. The flow or pressure device is under the control of a therapy device controller. The CPG device 1002 may also include one or more transducers (e.g., pressure, flow rate, temperature) that are located upstream of the pressure device. The one or more transducers are constructed and arranged to measure properties of the air at that point in the pneumatic path. Alternatively, or additionally, one or more transducers are located downstream of the pressure device, and upstream of the interface 1008. The one or more transducers are constructed and arranged to measure properties of the air at that point in the pneumatic path. Alternatively, or additionally, one or more transducers are located downstream of the interface 1008, and proximate to and/or within the compression garment 1004.

Input devices may include one or more of buttons, switches or dials to allow a person to interact with the CPG device 1002. The buttons, switches or dials may be physical devices, or software devices accessible via an optional touch screen of the CPG device 1002. The buttons, switches or dials may, in one form, be physically connected to the external housing, or may, in another form, be in wireless communication with a receiver that is in electrical connection to the central controller.

A central controller of the CPG device 1002 is a dedicated electronic circuit configured to receive input signal(s) from an input device, and to provide output signal(s) to an output device (e.g., one or more valves of a set of valve(s)) and/or the therapy device controller and/or a data communication interface of the CPG device 1002. The central controller can be an application-specific integrated circuit. Alternatively, the central controller can be formed with discrete electronic components.

The central controller of the CPG device can be configured to receive input signal(s) from one or more transducers, and one or more input devices. The central controller may also be configured with one or more digital and/or analog input/output ports as previously described such as for implementing the mode of operations and detection modules in conjunction with the operations of the system. For example, such input and/or output ports may provide control over or detect position of active pneumatic valves controlled by the central controller for directing compression related pressure to pneumatic chambers of the compression garment 1004.

In some implementations of the present disclosure, a system 1000 is configured to deliver compression therapy to a user wearing the compression garment 1004 under the control of the central controller. The system may include a controllable flow or pressure device, such as the CPG device 1002. Such a device may be implemented with a blower, such as a servo-controlled blower. Such a blower may be implemented with a motor having an impeller in a volute.

In some implementations, the CPG device 1002 includes memory, preferably non-volatile memory. The memory may include battery powered static RAM memory, volatile RAM memory, EEPROM memory, NAND flash memory, or any combination thereof. The memory can be located on a PCBA. Additionally, or alternatively, the CPG device 1002 can include a removable form of memory, for example, a memory card made in accordance with the Secure Digital (SD) standard. The memory can act as a computer readable storage medium on which is stored computer program instructions expressing the one or more methodologies described herein, such as the one or more algorithms discussed herein.

Transducers may be internal to the CPG device 1002, or external to the CPG device 1002. External transducers may be located on or form part of, for example, the CPG device 1002, the conduit and/or valve interface 1008, and/or the compression garment 1004.

In some implementations, an output device may take the form of a valve driver for a set of active valves such as the pneumatic valves of the interface 1008, which may be integrated with the CPG device 1002, the compression garment 1004 and/or a discrete device board serving as the interface 1008. Each of such active valves may be a pneumatic valve configured to receive a control signal to directionally gate and/or proportionally permit transfer of air selectively through the valve.

For example, an output device may include one or more valve driver(s) for one or more active valves. Such output devices may receive signals from the central controller for driving operation of the valves. Such valve driver(s) or valves may be discrete from the CPG device 1002 external housing and coupled to the CPG device 1002 via a bus, such as a Controller Area Network (CAN) bus such as where the central controller 4230 includes a CAN bus controller. A suitable electrical coupler portion of link 1006 may serve to couple the bus with the valve driver and/or valves. The active valves may be any suitable pneumatic valve for directing air flow, such as a gate valve, a multi-port valve, or a proportional valve, any of which may be operated by an included solenoid. In some implementations, the active valves and valve drivers may be within the CPG device 1002 housing or in a discrete housing of an interface (e.g., conduit and/or valve interface 1008) or in the compression garment 1004.

A compression garment 1004 in some implementations includes one or more pneumatic chambers that may be inflated and/or deflated by operation of the CPG device 1002 via one or more pneumatic lines leading to the pneumatic chambers of the compression garment 1004. Such activation may be implemented with one or more active valves and/or passive valves. The garment may typically be lightweight, flexible and washable and may employ a compression fabric.

In some implementations, the compression garment 1004 is formed with layers, such as an inner layer (e.g., inner sleeve) and an outer layer (e.g., outer sleeve) that may be coupled together to assist with forming an air chamber. The garment may be manufactured with a breathable fabric, serving as an inner skin contact interface. Such a material may serve as a barrier to direct user contact with a less permeable material that forms a set of pneumatic chambers of the garment. In some implementations, one or more layers of the garment (e.g., the skin contacting layer) includes polyester, elastane, nylon, and thermoplastic polyurethane (TPU). In some such implementations, the TPU is used as a backing to aid in making the garment airtight or near airtight. The proportion of polyester, elastane, and nylon can be adjusted to modify the elasticity of the garment (e.g., the skin contacting layer). In some implementations, a weave technique of one or more layers of the garment can be adjusted to modify the elasticity of the garment.

The chambers and pneumatic pathways may be formed between the layers. In some forms, the outer layer may be made of a three-dimensional knitted fabric. The outer layer may include one or more moulded portions, such as in a form of a brace, to more rigidly support certain anatomical regions of the limb (e.g., a forearm brace or leg brace) such as along one side of the sleeve. Some areas of the garment may include stretchable or flexible regions to permit movement (e.g., elbow, wrist, ankle or knee regions). Moreover, moulded portions may include pneumatic couplings and/or pneumatic pathways. Such component regions (e.g., of thermoplastic elastomer TPE such as Santoprene) may be sewn into the fabric of the garment, co-moulded, or ultrasonically welded to the fabric.

The garment may be generally formed as a sleeve that can be applied around the bodily area of therapy. For example, it may be an arm sleeve, a partial arm sleeve, an above-the-knee leg sleeve, a full leg sleeve, a foot sleeve, a toe-to-thigh sleeve, an ankle-to-knee sleeve, etc.

The compression garment 1004 can include a set of pneumatic chambers positioned about the compression garment 1004 that are sized and located to promote a desired compression therapy. The depicted compression garment 1004 is a lower leg type compression garment with a partial upper foot portion and a leg portion that each provides different sets of chambers or cells for separately compressing discrete portions of the foot and/or leg that are covered by the compression garment 1004. These chambers may be activated in zones, such as a set of chambers in a knee-thigh zone KTZ, a set of chambers in a calf-knee zone CKZ, and a set of chambers in a foot-calf zone FCZ.

The pneumatic chambers may be formed with a material having baffles (e.g., chamber material folds) to more readily permit a vertical expansion of the chamber. The pneumatic chamber may be box shaped with one or more edge folds, such as at each of an inlet end and an outlet end. Such folds may also be at sides of the chamber (not illustrated). Such folds can permit a more uniform rising of the user side surface of the box to provide a more evenly applied compression surface area such as when compared to a more rounded, balloon-shaped type of chamber. Each chamber can provide an isolated compressive force at the surface of the chamber in contact with a user from inflation of the pneumatic chamber, such as in relation to activation of an active valve and/or passive valve, in the location of the inflation. Multiple chambers can be activated to distribute the compressive force. They may also be sequentially activated to move the location of the compressive force.

The compression garment(s) of the present disclosure may also include, or be configured to retain, pneumatic pathways (such as in moulded portions) or conduits inserted therein to fluidically couple pneumatic connecting lines, such as from the interface 1008 and/or the CPG device 1002 for pneumatic purposes, to the pneumatic chambers of the compression garment. Such pathways may also couple discrete pneumatic chambers together, such as when the chambers are separated by a passive valve. In some versions, one active valve may direct gas flow via such a conduit or pathway in relation to one pneumatic chamber or in relation to a group of pneumatic chambers. Thus, a pathway of the compression garment may couple a group of pneumatic chambers or a single pneumatic chamber. Thus, in some cases different active valves may be coupled to different pneumatic chambers or different groups of pneumatic chambers via the pathways of the compression garment. In some versions, the compression garment may include integrated active valves distributed throughout the compression garment. In some versions, the compression garment may include couplers for attachment of pneumatic conduits and/or electrical lines such as to the integrated active valves.

Distributed valving confers a number of advantages on a compression garment. With distributed valving, the interface 1008 is a conduit interface with a single pneumatic connection to the link 1006 and a single pneumatic connection to the garment 1004, along with electrical connections to each of the distributed active valves. This enables the garment to be lighter and less bulky.

Various configurations of the compression garment(s) of the present disclosure can be provided based on the type of compression therapy and target portion of the body of the user (e.g., patient).

Some implementations of the compression garments of the present disclosure are designed for leg and/or foot therapies/compression. Examples of such leg and/or foot/boot compression garments are illustrated in FIGS. 1 and 9 to 16.

In some implementations, a compression garment 1004 can includes a barbed-type pneumatic coupling for establishing a pneumatic connection between the compression garment 1004 and the CPG device 1002 via the link 1006. Such a pneumatic coupling may be co-moulded with the exo-skeleton structure, sewn/stitched into the fabric or ultrasonically welded to the fabric.

In some versions of the compression garment 1004, one or more anatomically shaped pneumatic chambers may provide muscular based zones (anatomically shaped surfaces of the pneumatic chambers) for focused compression therapy. Such muscular based zones, such as for location at the major muscle groups of the arms or legs, can provide targeted manipulation of each muscle area to support lymphatic function and blood flow. In some versions, knitted fabric can separate the set of pneumatic chambers (one or more) in each muscle zone from other muscle zones.

In some implementations, the compression garments of the present disclosure comprise anatomically shaped chambers based on the key points which a physical therapist focuses on when performing Manual Lymphatic Drainage (MLD). As an example, for Lower Limb lymphedema, these points may be inner to outer thigh, behind the knee, the sides of the calf, around the ankle and extremities. This enables the system 1000 to emulate MLD accurately. Such points may each be implemented as one or more zones and may be configured with active and/or passive valves to produce the desired directional manipulation of the points as previously discussed.

In some implementations, the compression garments of the present disclosure may be implemented with a modular configuration to permit use of multiple garments with a common CPG device 1002.

In some implementations, a modular compression garment can include an upper leg compression garment, a lower leg compression garment, and/or a boot or foot compression garment (see FIGS. 1 and 9 to 16). An upper leg compression garment and lower leg compression garment can have a chaining interface located in a region of the respective garments for direct coupling to a conduit and valve interface of a neighbouring garment. Thus, compression therapy of the several garments may be implemented by bussing signals (pneumatic and electrical) through the respectively coupled garments with a single CPG device 1002 connected to the modular compression garment via an interface.

The system 1000 may include a control device 1010 (FIGS. 1 and 2) (e.g., a mobile phone or tablet computer) for running an application concerning operations with the CPG device 1002 and use of one or more compression garments of the present disclosure (e.g., compression garment 1004). Thus, the control device 1010 may include integrated chips, a memory and/or other control instruction, data or information storage medium for such an application. For example, programmed instructions or processor control instructions encompassing the operation methodologies of the control device described herein may be coded on integrated chips in the memory of the device or apparatus to form an application specific integrated chip (ASIC). Such instructions may also or alternatively be loaded as software or firmware using an appropriate data storage medium. Optionally, such processing instructions may be downloaded such as from a server over a network (e.g. the Internet) to the processing device such that when the instructions are executed, the processing device serves as a screening or monitoring device. Thus, the server of the network may also have the information storage medium with such instructions programmed instructions or processor control instructions and may be configured to receive requests for downloading and transmitting such instructions to the control device. In some versions, a portal system described herein may be such a server.

A portal system 2028 (FIG. 2) may be implemented, such under the control of a clinician or provider, to manage a population of users of compression therapy systems. A clinician or other provider (e.g., health care provider) can serve multiple patients such as by screening patients by medical check-up and prescribing treatment with compression therapy systems 1000 (FIGS. 1 and 2). For example, the provider may test a patient using a diagnostic process of a compression therapy system described herein and such testing data along with patient identification information may be uploaded to the portal system server application. Clinical data and therapy information from continued use of the system 1000 by the patients can also be uploaded to the portal system 2028 as previously described. The clinician or provider, having access to the portal system 2028, can then use the portal to help customize care to the individual patient's needs via the portal system 2028. For example, body metrics (e.g., body composition, girth, etc.) collected using the system 1000 can be transferred to the portal system 2028, which when combined with medical data of the patient, can drive the system 1000 to change settings and therapy parameters to customize the patient's therapy regimen such as by the automated application of the system 1000 and/or by the guidance of the provider or clinician. Notification of care changes can be made to the patient within the portal system 2028, which in turn can communicate with the control device(s) (e.g. control device 1010) for changing settings of the CPG devices (e.g., CPG device 1002). In some examples, body metric data maintained by the system 1000 may include: body composition, skin density, skin composition, impedance, volume, girth, resistance, swelling, bioimpedance, temperature, etc., or any combination thereof.

The portal system 2028 may also utilise data analytics methods to personalize care plans. The portal could utilise patient history, therapy data and any diagnostic data to automatically recommend and/or adjust treatment plans. An example of this could be to incorporate data coming from an Indocyanine-Green (ICG) scan, which maps out the flow of fluid through the lymphatic networks. This data could provide information on how to personalize the compression waveform for a particular patient, such that applied direction of compression matches the natural flow of the lymphatic system (as seen in the scan). Following the initial setup in this manner, as the portal system 2028 may receive data from a CPG device over time, as well as clinical data entered from the physician, the portal system 2028 could continue to adapt therapy patterns accordingly. This is one example of how the portal system 2028 can personalize care plans for a patient. Apart from therapy, the portal system 2028 can also recommend changes to exercise patterns, diet, and lifestyle.

Compression garment systems, such as pneumatic compression garment systems, provide therapeutic relief for circulatory-related disorders, including lymphedema. For example, in some implementations, a pneumatic compression garment provides a pneumatic compression, including a gentle repetitive massage delivered by inflating (e.g., pressurizing) and deflating (e.g., depressurizing) cells (e.g., one or more air chambers), in a wearable garment wrapped or otherwise fitted about a user's limbs (e.g., arm, leg, foot). For the circulatory-related disorder therapy to be effective, the wearable garment needs to be applied and remain secured onto the limb while the air chamber(s) are in an inflated state and a deflated state.

Desirable aspects of the present disclosure include delivering circulatory-related disorder therapy to a subject, such as a user or patient, using a compression garment. Delivering effective circulatory-related disorder therapy to some regions of the body, such as the foot and ankle regions, can be complicated due to the anatomical structure of the body part being receiving therapy, in particular with lymphedema patients who have varying levels of swelling in the region. Swelling for lymphedema patients often changes significantly over the course of having the condition. It can be desirable to provide compression all around a foot, for example, rather than just to certain targeted sections of the foot, while providing support of the compression garment components and the foot itself to allow walking, while still maintaining reasonable ease of use of the compression garment by the patient. The present disclosure contemplates a compression garment that allows the patient to walk while wearing a foot compression garment.

Other desirable aspects of the present disclosure include providing tube guides in a compression garment that reduce or minimize entanglement or dislodging that can occur in a compression garment. The tube guides maintain air supply tubes on a predetermined pathway in or on the garment. The air supply tubes supply pressurized air to respective one(s) of one or more independently pressurized macro-chambers of the compression garment.

Another desirable aspects of the present disclosure, air supply channels are contemplated in a multi-layer compression garment with three or more layers where the air supply channels are integrally formed within the garment between any two layers. The air supply channels supply pressurized air to respective one(s) of one or more independently pressurized macro-chambers of the compression garment.

Yet a further desirable aspect of the present disclosure includes an interface on a compression garment including a main air supply valve that is pneumatically connected to a central air supply line. The main air supply valve is located on or in the compression garment and controls the supply of pressurized air to at least two chamber valves that supply pressurized air to a corresponding air chamber of the compression garment.

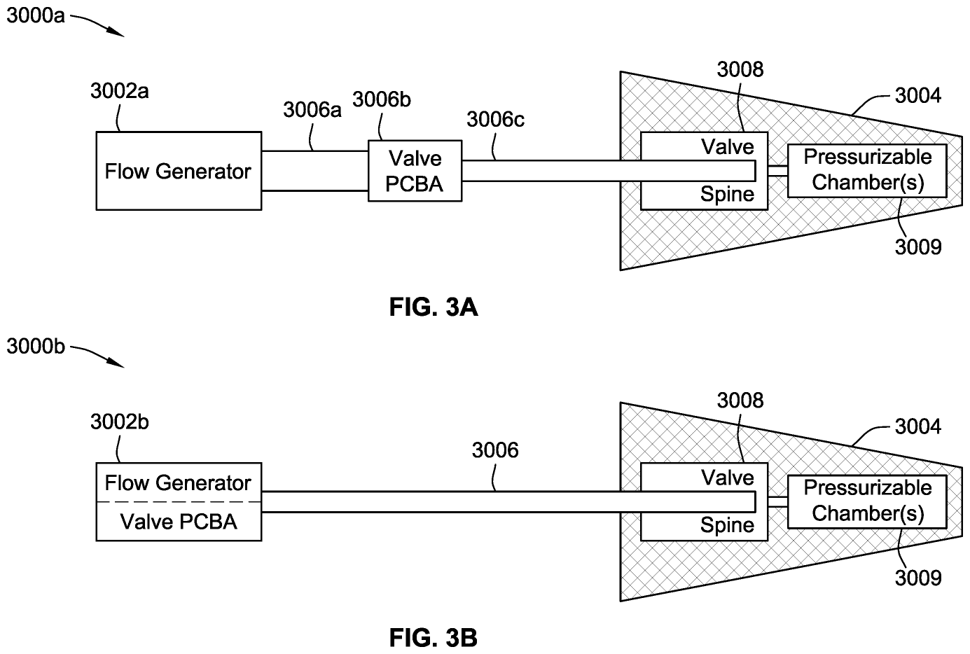

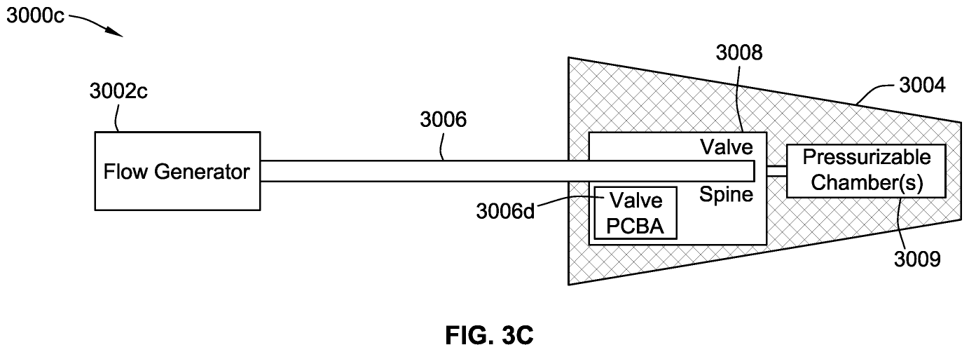

Turning now to FIGS. 3A and 3B, block diagrams are provided of exemplary compression therapy systems 3000a, 3000b, 3000c that include components of the compression therapy systems 1000 of FIGS. 1 and 2. The compression therapy systems 3000a, 3000b, 3000c include CPG device 3002a, 3002b, similar to the CPG device 1000 described in FIGS. 1 and 2.

In FIG. 3A, the CPG device 3002a includes a flow generator that is external to the compression garment 3004. The CPG device 3002a further includes a controller, having one or more processors, that transmits instructions via a first link 3006a, that is a combined pneumatic tube and electrical coupling for control and operation of the compression garment 3004. The first link 3006a connects the CPG device 3002a to a valve control component 3006b that includes a printed circuit board assembly (PCBA) configured to issue commands for turning valves in a valve spine interface 3008 in the compression garment 3004 on and off. The valve control component 3006b is connected to the valves in the valve spine interface 3008 via a second link 3006c, that is a combined flexible PCBA and a main air supply line. The valve control component 3006b transmits the electrical command signals via the second link 3006c to the respective valves in valve spine interface 3008. The flexible PCBA in the second link 3006c includes separate control lines for each valve used to pressurize and depressurize the compression garment 3004. In some implementations, the pneumatic tube and electrical coupling of the first link 3006a are not combined and are separate components. Similarly, in some implementations, the flexible PCBA and the main air supply line of the second link 3006c are not combined and are separate components. In some implementations, a cable with multiple wires (e.g., multi-core cable) can be an alternative to the flexible PCBA.

In FIG. 3B, the valve control component 3006b of FIG. 3A is integrated into the CPG device 3002b. The CPG device 3002b includes one or more controllers, with one or more processors, that transmit instructions via a link 3006, that is a combined pneumatic tube and electrical coupling for control and operation of the compression garment 3004. The controller(s) of the CPG device 3002b transmit commands and control valves in the valve spine interface 3008 directly without the intermediate valve control component 3006b included in the compression therapy system 3000a. The valve control component 3006b of compression therapy system 3000a is effectively integrated into a controller PCBA of the CPG device 3002b, where the CPG device 3002b is configured to issue commands for turning respective valves in a valve spine interface 3008 in the compression garment 3004 on and off. The electrical control in the link 3006 can be a flexible PCBA that includes separate control lines for each valve in the valve spine interface 3008 used to pressurize and depressurize the compression garment 3004. In some implementations, the pneumatic tube and electrical coupling of the link 3006 are not combined and are separate components. In some implementations, a cable with multiple wires (e.g., multi-core cable) can be an alternative to the flexible PCBA.

In FIG. 3C, the valve control component is a valve PCBA 3006d that is integrated into the valve spine 3008 that is further integrated into the compression garment 3004. The CPG device 3002c includes one or more controllers, with one or more processors, that transmit instructions via a link 3006, that is a combined pneumatic tube and electrical coupling for control and operation of the compression garment 3004. The instructions are received by the valve PCBA 3006d in the compression garment 3004. The valve PCBA 3006d is configured to issue commands for turning valves in a valve spine interface 3008 on and off.

As depicted in FIGS. 3A, 3B, and 3C, the valve spine interface 3008 is located in or on the compression garment 3004. The compression garment 3008 can include a plurality of pressurizable chamber 3009. The valve spine interface 3008 includes a plurality of chamber valves each configured to supply pressurized air to a corresponding chamber of the compression garment 3004 such that the pressurized air can be delivered to each of the plurality of pressurizable chambers 3009. A main air supply valve, that is also located on or in the compression garment 3004, is pneumatically connected to a central air supply line (e.g., the main air supply line of the link to the CPG device 3002a, 3000b) The main air supply valve controls the supply of pressurised air to at least two of the plurality of chamber valves of the valve spine interface 3008.

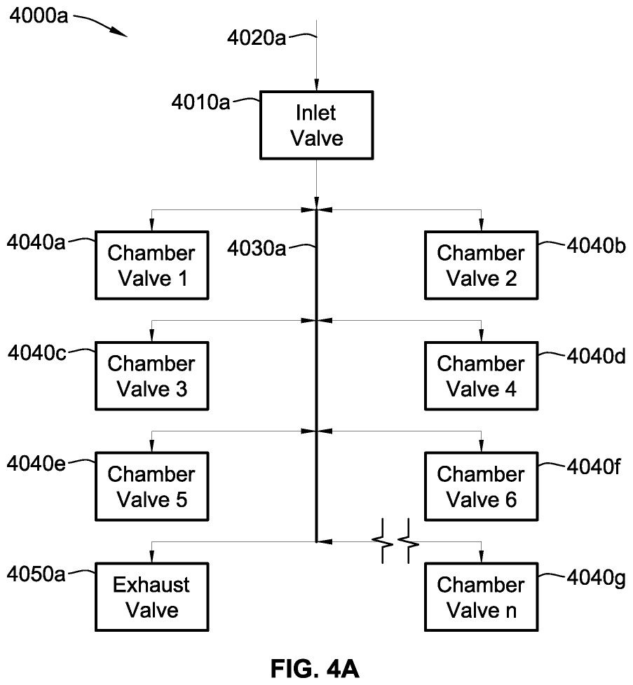

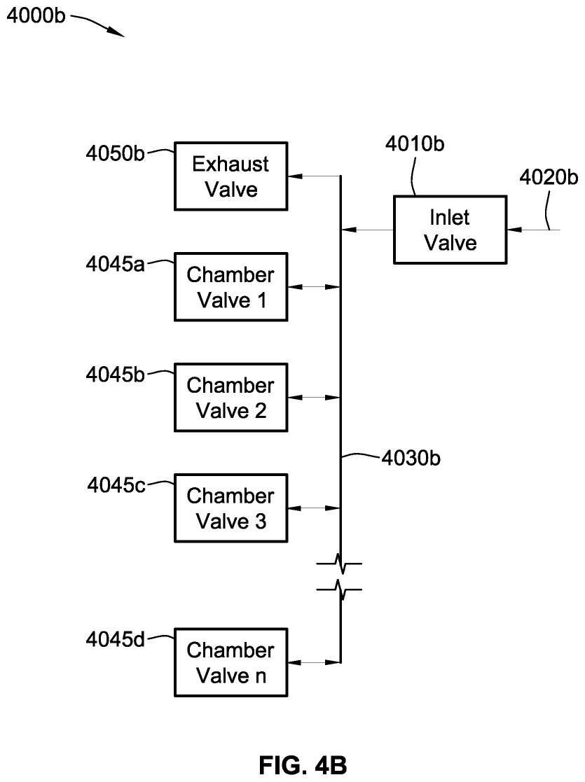

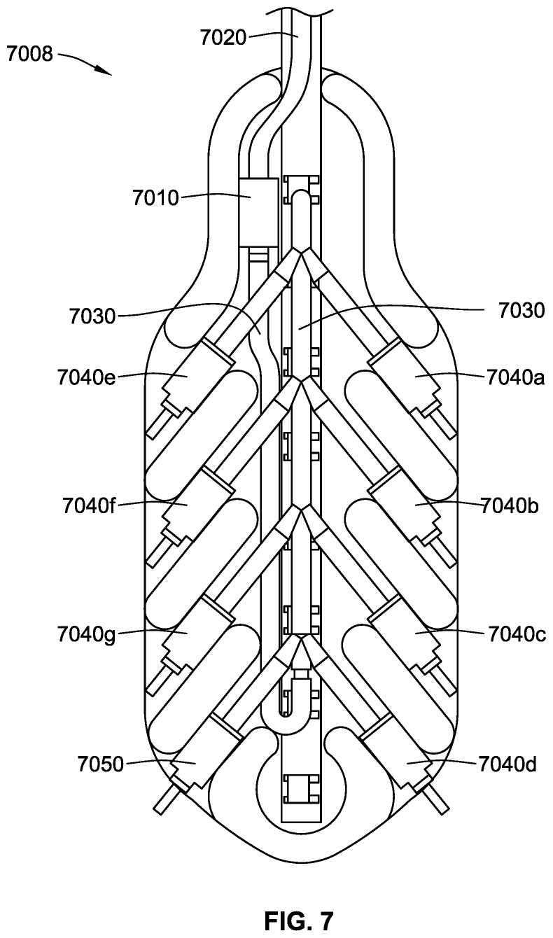

Turning now to FIGS. 4A and 4B, block diagrams of exemplary valve spine interface arrangements 4000a, 4000b for a compression garment with a plurality of chambers are illustrated. The valve spine interface arrangements 4000a, 4000b includes respective main air supply valves 4010a, 4010b that are a single inlet on-off valves. The main air supply valve 4010a, 4010b controls a unidirectional flow of pressurized air received from a central air supply line 4020a, 4020b, pneumatically connected to a CPG device (e.g., CPG devices 1002, 3002a, 3002b), and into a chamber air supply line 4030a, 4030b. FIG. 4A illustrates a specific configuration with the valves arranged in two parallel rows (see also FIG. 7). FIG. 4B illustrates an alternative arrangement where the valves are arranged in a single line.

In FIG. 4A, the chamber air supply line 4030a is pneumatically connected to the main air supply valve 4010a and to chamber valves 4040a-g. Flow in the chamber air supply line 4030a is bi-directional in that pressurized air can flow toward any of the chamber valves 4040a-g and pressurized air can also flow away from the chamber valves 4040a-g via the chamber air supply line 4030a. In one example, such a reverse flow of air may occur when the exhaust valve 4050 is turned on in order to remove air from the system. The chamber valves 4040a-g control the supply of pressurized air to corresponding chambers of a compression garment such that the pressurized air can be delivered to each of the plurality of chambers of the garment during the delivery of compression therapy to a user. The main air supply valve 4010a controls the supply of pressurized air into the chamber air supply line 4030a sourced from the CPG device as all pressurized air from the CPG device flows into the chamber air supply line 4030a through the main air supply valve 4010a via the central air supply line 4020a. Control of the main air supply valve 4010a provides for turning on and off the supply of air from the CPG device into the chamber air supply line 4030a in a centralized manner.

Similar to the valve spine interface 3008 in FIGS. 3A and 3B, the valve spine arrangement 4000a, including the main air supply valve 4010a, is located on or in the compression garment. The valve spine interface arrangement 4000a includes an exhaust valve 4050a that is pneumatically connected to the chamber air supply line 4030a. The exhaust valve 4050a, like the chamber valves 4040a-g and the inlet main air supply valve 4010a, is controlled by a controller that is part of a compression therapy system (e.g., compression therapy systems 1000, 3002a, 3002b). The exhaust valve 4050a, when opened, allows a unidirectional flow of pressurized air out of valve spine interface arrangement 4000a via the chamber air supply line 4030a. With the chamber air supply line 4030a pneumatically connected to the exhaust valve 4050a, and to each of the chambers valves 4040a-g, the pressure in the chambers of a compression garment can be adjusted by controlling the opening and closing of the exhaust valve 4050a.

In FIG. 4B, the chamber air supply line 4030b is pneumatically connected to the main air supply valve 4010b and to chamber valves 4045a-d. Flow in the chamber air supply line 4030b is bi-directional in that pressurized air can flow toward of any of the chamber valves 4045a-d and pressurized air can also flow away from the chamber valves 4045a-d via the chamber air supply line 4030b. The chamber valves 4040a-d control the supply of pressurized air to corresponding chambers of a compression garment such that the pressurized air can be delivered to each of the plurality of chambers of the compression garment during compression therapy. The main air supply valve 4010b controls the supply of pressurized air into the chamber air supply line 4030b sourced from the CPG device as all pressurized air from the CPG device flows into the chamber air supply line 4030b through the main air supply valve 4010b via the central air supply line 4020b. Control of the main air supply valve 4010b provides for the turning on and off the supply of air from the CPG device into the chamber air supply line 4030b.

Similar to the valve spine interface 3008 in FIGS. 3A and 3B, the valve spine arrangement 4000b, including the main air supply valve 4010b, is located on or in the compression garment. The valve spine interface arrangement 4000b includes an exhaust valve 4050b that is pneumatically connected to the chamber air supply line 4030b. The exhaust valve 4050b, like the chamber valves 4045a-d and the inlet main air supply valve 4010b, is controlled by a controller that is part of a compression therapy system (e.g., compression therapy systems 1000, 3002a, 3002b). The exhaust valve 4050b, when opened, allows a unidirectional flow of pressurized air out of valve spine interface arrangement 4000b via the chamber air supply line 4030b. With the chamber air supply line 4030b pneumatically connected to the exhaust valve 4050b, and to each of the chambers valves 4045a-d, the pressure in the chambers of a compression garment can be adjusted by controlling the opening and closing of the main air supply valve 4010b (e.g., the inlet valve) and the exhaust valve 4050b.

In some implementations, the main air supply valves 4010a, 4010b allow a non-zero flow of pressurized air that is less than the maximum supply of pressurized air into the respective chamber air supply line 4030a, 4030b, such as by the main air supply valve 4010a, 4010b being partially opened, rather than a fully open (e.g., fully on) or fully closed (fully off) position. In some implementations, the main air supply valves 4010a, 4010b control a plurality of different flows of pressurized air into the respective chamber air supply lines 4030a, 4030b.

A circulatory-related disorder therapy system, such as compression therapy systems 1000, 3000a, 3000b, 3000c, can include a compression garment 1004, 3004 as described for FIGS. 1 to 4, along with a CPG device for generating pneumatic pressure for pressurizing a plurality of chambers, a controller, and a controller device. The controller can include one or more processors and be configured to control operation of the CPG device in a therapy process to generate pneumatic pressure in the plurality of chambers of the compression garment during a therapy period. The control device includes one or more processors and a computer readable medium having processor control instructions, that when executed by at least one of the one or more processors of the control device, cause the control device to receive, from the controller, a parameter relating to the therapy process. In some implementations, the control device is a mobile phone or a tablet computer. In some implementations, the processor control instructions further cause the control device to (i) present a graphical user interface on a display of the control device; (ii) receive, through the graphical user interface, a command from a user, the command being configured, when received, to cause the controller to change the operation of the compression pressure generator in the therapy process; and (iii) transmit, to the controller, the received command. In some implementations, the controller can further be configured to selectively control operation of the main air supply valve and the plurality of chamber valves.

The main air supply valve 4010a, 4010b is further desirable because it provides for the centralized shutting off of air flow from a flow generator (such as a CPG device 1002, 3002a, 3002b, 3002c described in FIGS. 1 to 3) into the entire set of valves of the valve spine interface arrangement (such as interface arrangements 3008, 4000a, 4000b in FIGS. 3 and 4) during deflation and allows for a smooth, passive and efficient deflation of a compression garment.

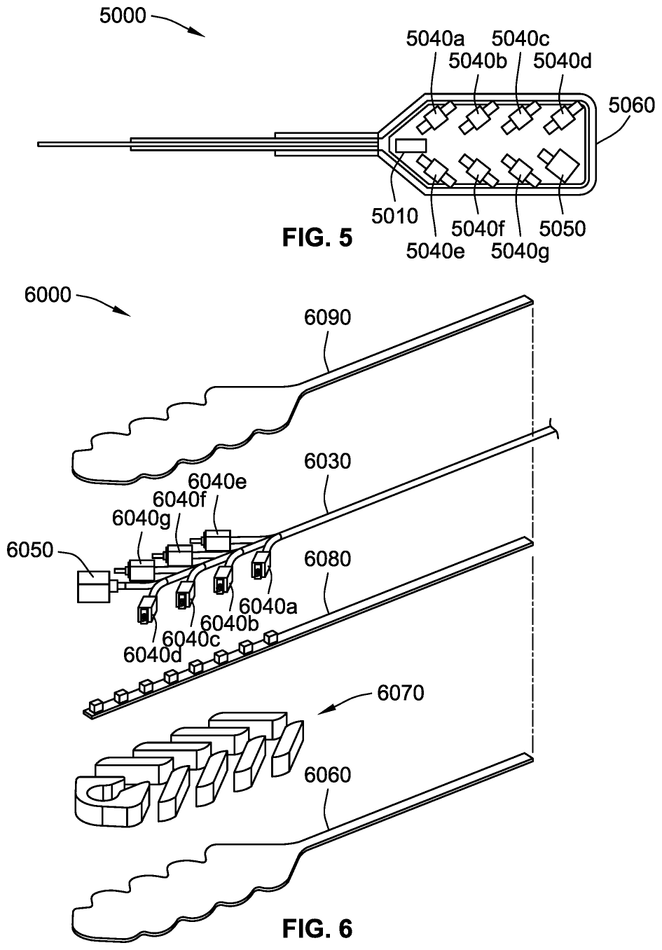

Turning now to FIG. 5, a top view of a partial exemplary centralized valve spine interface arrangement 5008 is depicted based on valve spine interface block diagram of FIG. 4A. The valve spine interface arrangement 5008 includes a main air supply valve 5010, a plurality of chamber valves 5040a-g, and an exhaust valve 5050, laid out in a generally tree-like pattern on a support chassis 5060.

Referring now to FIG. 6, a partially exploded perspective view of an exemplary centralized valve spine arrangement 6008, similar to the valve spine arrangement of FIG. 5, is depicted including additional components not depicted in FIG. 5. From bottom to top, the valve spine arrangement 6008 includes a (a) support chassis 6060, that may be silicone-based or foam or other materials, (b) spacer pads 6070 that subdivide the space, protect, separate, and/or maintain in place the chamber valves 6050a-g and exhaust valve 6050 and can also be made from silicone foam; (c) a flexible PCBA 6080 circuit board connected to and controlling the chamber valves 6040a-g and exhaust valve 6050; and (d) a chamber air supply line 6030 for carrying pressurized air to the arrangement of chamber valves 6040a-g and exhaust valve 6050. The chamber valves are pneumatically connected via additional airflow line (not shown) to respective macro-chambers of a compression garment. Finally, the valve spine arrangement includes a top cover layer 6090 that may be similar to the support chassis 6060.

In some implementations, the valve spine arrangements 3008, 4000a, 4000b, 5008, 6008 can be attached in a pocket, e.g., between a skin contacting layer and outer layer, of a compression garment 1004, 3004. It is contemplated that the foam chassis 6070 can provide some rigidity for mechanical integrity of the valve spine arrangement where such rigidity is not sufficient from the other components of the valve spine arrangement. Alternatively, in some implementations, a valve spine arrangement can be attached to the outer layer of a compression garment. A rigid chassis support 6060 and/or top layer 6090, encapsulating the valve spine arrangement, can provide mechanical integrity if the main elements of the valve spine arrangement themselves do not provide sufficient rigidity to protect valves 6040a-g, 6050, air supply lines 6030, and flexible PCBA 6080.

Referring now to FIG. 7, a top partial view is depicted of an exemplary valve spine arrangement 7008. The arrangement is similar to the valve spine arrangement of FIG. 6, and further includes a main air supply valve 7010, similar to the arrangement in FIG. 4A. The main air supply valve 7010 controls a unidirectional flow of pressurized air, received from a central air supply line 7020 that is pneumatically connected to a CPG device (e.g., CPG devices 1002, 3002a, 3002b), and directs the pressurized air into a chamber air supply line 7030. The chamber air supply line 7030 is pneumatically connected to the main air supply valve 7010 and to chamber valves 7040a-g and an exhaust valve 7050. Flow in the chamber air supply line 7030 is bi-directional in that pressurized air can flow toward of any of the chamber valves 7040a-g, and pressurized air can also flow away from the chamber valves 7040a-g via the chamber air supply line 7030 and into the exhaust valve 7050. The chamber valves 7040a-g control the supply of pressurized air to corresponding chambers (not shown) of a compression garment such that the pressurized air can be delivered to each of the plurality of chambers of the garment during the delivery of compression therapy to a user. The main air supply valve 7010 controls the supply of pressurized air into the chamber air supply line 7030 that is sourced from the CPG device. All pressurized air from the CPG device flows from the central air supply line 7020 and into the chamber air supply line 7030, via the main air supply valve 7010. Control of the main air supply valve 7010 provides for a centralized turning on and off the supply of air from the CPG device into the chamber air supply line 7030 and into any of the valves.

The valve spine interface arrangement 7008, including the main air supply valve 7010, is located on or in the compression garment. The valve spine interface arrangement 7008 includes an exhaust valve 7050 that is pneumatically connected to the chamber air supply line 7030. The exhaust valve 7050, like the chamber valves 7040a-g and the inlet main air supply valve 7010, is controlled by a controller that is part of a compression therapy system (e.g., compression therapy systems 1000, 3002a, 3002b). The exhaust valve 7050, when opened, allows a unidirectional flow of pressurized air out of valve spine interface arrangement 7008 and to atmosphere, via the chamber air supply line 7030. With the chamber air supply line 7030 pneumatically connected to the exhaust valve 7050, and to each of the chambers valves 7040a-g, the pressure in the chambers of a compression garment can be adjusted by controlling the opening (exposed to atmosphere) and closing (sealed from atmosphere) of any of the exhaust valve 7050 and the inlet main air supply valve 7010.

Deflating pneumatic arrangements, such as valve arrangement 7008, without a main air supply valve 7010 can be problematic if an inflow of pressurised air is allowed in the system during the deflation process. Thus, including the main air supply valve 7010 can be advantageous by providing smooth, passive, and efficient deflation of the chambers of a multi-chamber compression garment. For example, the use of the main air supply valve 7010 can minimize issues that can be experienced during deflation when there is an uneven distribution of inflated volume across a chamber creating longer air flow paths from the chamber back to the chamber valve. In addition, the use of the main air supply valve 7010 allows a definitive control and/or termination of any continued air flow from the CPG device into the valve spine interface arrangement 7008 while deflating the chambers of the compression garment.

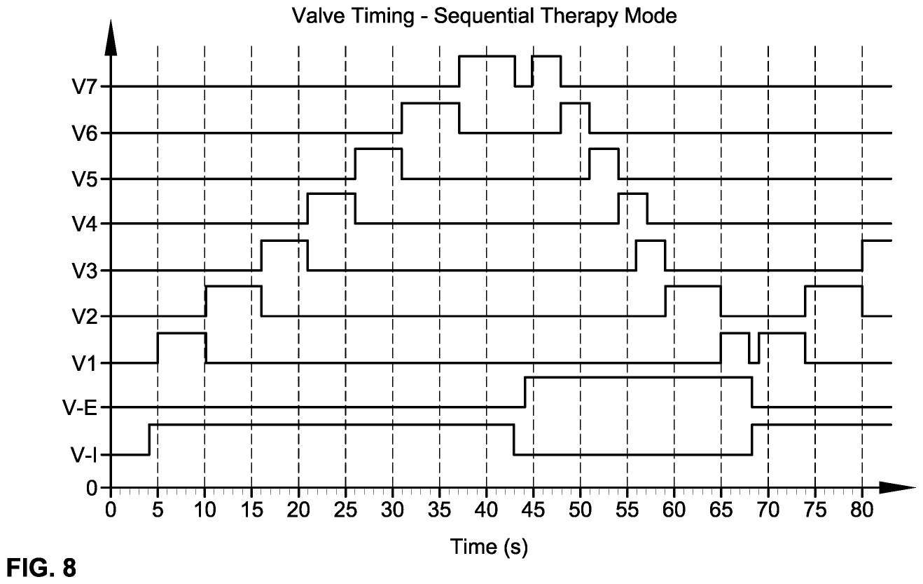

FIG. 8 is a graph depicting valve timing cycle for an exemplary implementation of a compression therapy mode associated with a valve spine arrangement, similar to the valve spine arrangement of FIGS. 4A, 4B, and 7. Valves V1 to V7 represent chamber valves, such as chamber valves 4040a-g, 4045a-d, 7040a-g. Valve V-E represents an exhaust valve, such as exhaust valves 4050a-b, 7050. Valve V-I represents a main air supply valve, such as main air supply valves 4010a-b, 7010. Valve V-I is open (or turned on) between four and forty-three second, valves V1 to V7 are sequentially opened and closed (turned on and turned off), starting with chamber valve V1, so that pressurized air enters the corresponding chamber of the compression garment associated with valves V1 to V7. Sequential timing of the valves can be desirable to provide uniform inflation of the chambers of the compression garment.

During the illustrative timing cycle of four and forty-three second timeframe, the exhaust valve V-E is closed thereby sealing the chamber air supply line from atmosphere. Then, starting around time forty-three and forty-four seconds through to sixty-eight seconds, the main air supply valve V-I is closed (or turned off) to stop the flow of pressurized air into the chamber air supply line and exhaust valve V-E is opened to atmosphere. In addition, starting around time forty-five and through to sixty-eight seconds, chamber valves V7 to V1 are also sequentially opened in the reversed order of the chamber filling cycle and the air in the corresponding chambers for V7 to V1 is released to atmosphere through the exhaust valve V-E. Once the garment is deflated, the exhaust valve V-E can be turned off or closed to allow later reinflation of the chambers connected to the chamber valves. For example, at time six-eight seconds when exhaust valve V-E is turned off, valve V-I is opened again and the valve timing cycle repeats.

FIG. 8 and the related description represents only one of many different valve timing cycles that can be implemented on a compression therapy device. FIG. 8 also provides one non-limiting example of the interplay between the main air supply valve 4010a-b, 7010, the exhaust valve 4050a-b, 7050, and the chamber valves 4040a-g, 4045a-d, 7040a-g, and how the described valve spine interface arrangements can control air flow from the CPG device and to the valves. In some implementations, it is contemplated that the main air supply valve 4010a-b, 7010 can also control the pressure provided to the valves.

In some implementations, the described centralized valve spine arrangements 5008, 6008, 7008 are used on a compression garment including a plurality of independently pressurizable macro-chambers for implementing circulatory-related disorder pressure therapy. The chamber valves 4040a-g, 4045a-d, 5040a-g, 6040a-g, 7040a-g are pneumatically connected to at least one of the plurality of independently pressurizable macro-chambers within the compression garment. The macro-chambers of the garment can be subdivided an a plurality of micro-chambers. The micro-chambers can be so interconnected that airflow/pressure provided to one or more of them, can reach all micro-chambers within a single macro-chamber, and even be passed on to an adjacent macro-chamber. The chamber air supply line 4030a, 4030b, 6030, 7030 is pneumatically connected with each one of the plurality of chamber valves 4040a-g, 4045a-d, 6040a-g, 7040a-g to provide independent pressurization of the chambers.

In some implementations, the top layer 6090 of FIG. 6 is positioned above the plurality of valves 6040a-g, 6050. The supporting chassis 6060 and the top layer 6090 can be arranged to enclose at least a portion of the chamber air supply line 7030 and/or at least a portion of the main air supply line 7020, along with the spacer pads 6070, the PCBA 6080 (which may be flexible, rigid, semi-rigid), and the plurality of valves 6040a-g, 6050. The valve spine arrangement 5008, 6008, 7008 can be sized and configured for attachment to an area of the compression garment such that, when the compression garment is placed on a user's limb, the valve spine arrangement does not extend across a joint of the limb. In some implementations, the joint is a user's elbow. In some implementations, the joint is a user's knee.

In some implementations of the valve spine arrangements 5008, 6008, 7008, the shape of the top layer and the bottom layer are substantially the same. In some implementations, the top layer is fabricated from a semi-rigid material. In some implementations, the bottom chassis support layer is fabricated from a semi-rigid material.

In some implementations of the valve spine arrangements 5008, 6008, 7008, a portion of an elongated PCBA, such as PCBA 6080, is disposed between a plurality of valve spacer pads, that may be fabricated with a semi-rigid material.

In some implementations of the valve spine arrangements 5008, 6008, 7008, the valve spacer pads and the plurality of valves are positioned at an acute angle to a longitudinal axis of the chamber air supply line 6030, 7030 and a longitudinal axis of the elongate PCBA layer 6080.

In some implementations of the valve spine arrangements 5008, 6008, 7008, the valve spacer pads and the plurality of valves are positioned at an acute angle to a transverse axis perpendicular the chamber air supply line 6030, 7030 and a transverse axis perpendicular to the long axis of the elongated PCBA.

In some implementations of the valve spine arrangements 5008, 6008, 7008, the plurality of valves 5040a-g, 5050, 6040a-g, 6050, 7040a-g, 7050 are configured to be operated by a controller associated with a PCBA layer, such as PCBA layer 6080, with the controller selectively directing pressurized air from the chamber air supply line 6030, 7030 to respective air chambers of the compression garment.

In some implementations of the valve spine arrangements 5008, 6008, 7008, the plurality of valves 5040a-g, 5050, 6040a-g, 6050, 7040a-g, 7050 is further configured to be operated by the controller to cycle pressurization of the plurality of chambers of the compression garment between at least two different pressure levels to provide a massage to a user wearing the compression garment on a body part. The two pressure levels may vary with time. The transition between the pressure levels may be continuous or incrementally stepped.

In some implementations of the valve spine arrangements 5008, 6008, 7008, a valve spine arrangement is disposed underneath an outer layer of the compression garment and extends from approximately an above-the-knee location to a thigh location of the compression garment during operation by a user. In some implementations, the valve spine arrangement is attached to outer layer of the compression garment and extends from approximately above a knee location to a thigh location of the compression garment during operation by a user. In some implementations, the valve spine arrangement is attached to outer layer of the compression garment.

In some implementations, the valve spine arrangements 5008, 6008, 7008 are compact where the valve spine arrangement does not extend across a joint to limit or minimize complications within the valve spine arrangement, such as the dislocation of entanglement of air supply channels, tube guides, or air supply tubes within the valve spine arrangement.

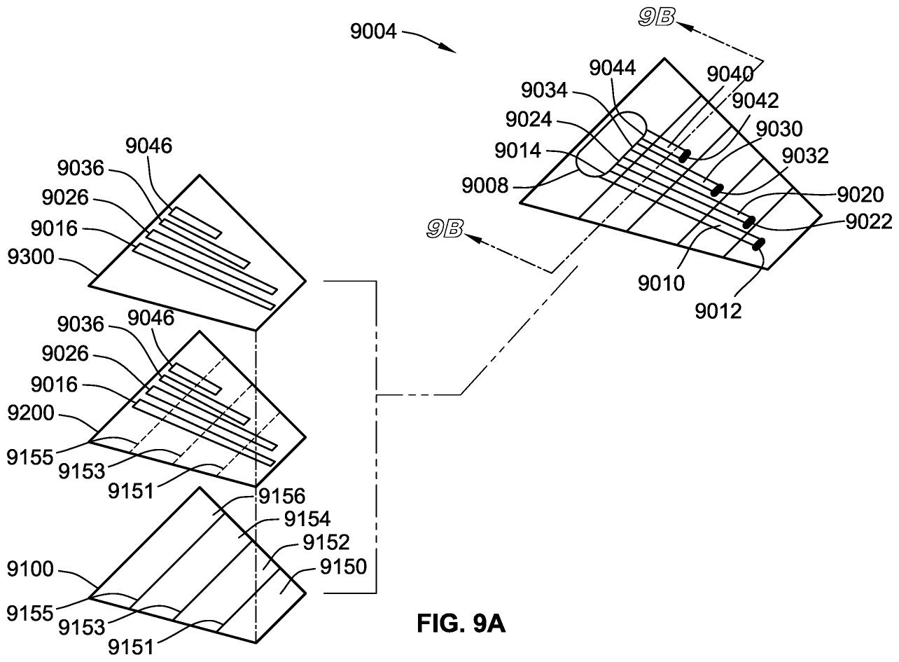

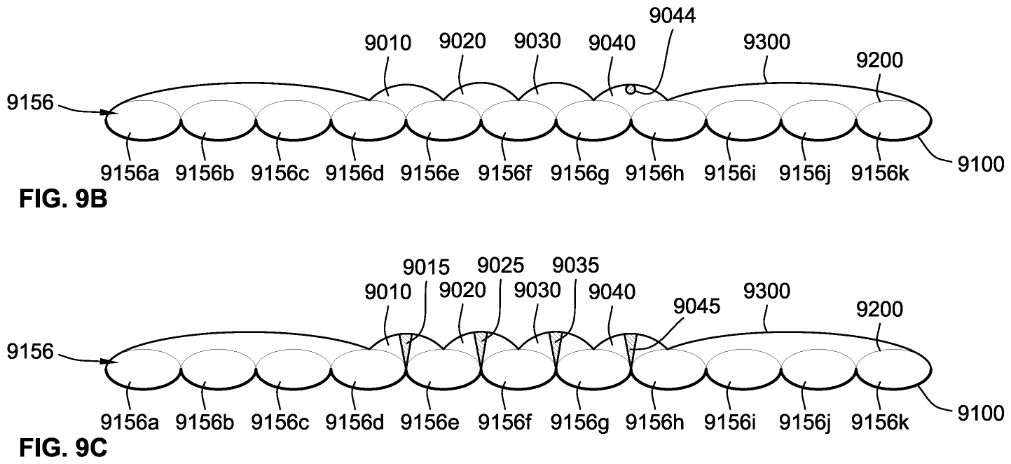

Turning now to FIGS. 9A to 9C, exemplary exploded perspective and cross-sectional schematic views are depicted of different layers of a three-layer compression garment 9004. Air supply channels 9010, 9020, 9030, 9040 are formed between layers 9200, 9300 of the three-layer compression garment 9004. The three-layer compression garment 9004 can be advantageous for creating air supply channels in a compression garment for supplying pressurized air from pneumatically connected chamber valves (see FIGS. 3 to 7) of a valve spine interface arrangement 9008, similar to the valve spine arrangements 1008, 3008, 4000a, 4000b, 5008, 6008, 7008 described in FIGS. 1 to 7.

In some implementations, the three-layer compression garment 9004 includes two layers (e.g., intermediate layer 9200, top layer 9300) dedicated to forming the air supply channels 9010, 9020, 9030, 9040. A separate bottom layer 9100 (e.g., layer closest to skin) and the intermediate layer 9200 are dedicate to forming a plurality of macro-chambers 9150, 9152, 9154, 9156 for the compression garment 9004. It is contemplated in some aspect that macro chambers may be subdivided into a plurality of interconnected inflatable micro-chambers. In such an arrangement where the air supply channels are formed within the same area/space as the macro-chambers, albeit at a different level (e.g. above the macro-chamber), means that a three-layer configuration for the compression garment 9004 provides additional space within the same overall perimeter foot-print of the compression garment 9004 that would not be otherwise there in a two-layer system. For example, a two-layer compression garment with similar air supply channels, along with macro-chambers both formed between two layers, has less space available for the macro-chambers because the available garment space has to be divided between into space for channels and space for chambers. In addition, less space is available for providing compression therapy.

In some implementations, the air supply channels 9010, 9020, 9030, 9040 formed between the intermediate layer 9200 and top layer 9300 can include structural support formations for the air supply channels, such as ribs extending in the top layer 9300, or within the air supply channel itself, along the longitudinal axis of the air supply channels to provide some rigidity to an air supply channel. The add rigidity aids in minimizing closure of an air supply channel during use of the compression garment during compression therapy. An example of a longitudinal structural rib (e.g. in the form of a weld line 9044) is provided in FIG. 9B for air supply channel 9040. An alternative form of the structural rib is shown in FIG. 9C, where one or more structural ribs are included in each air supply channel 9010, 9020, 9030, 9040. It is further contemplate that structural ribs could also be positioned along the top of the air supply channels 9010, 9020, 9030, 9040, or in the top layer 9300, that are transverse to the longitudinal axis of the air supply channel 9010, 9020, 9030, 9040. Other forms of structural support for the supply channels may include spacer(s) (not shown) distributed at least along a portion of the length of one or more channels (e.g., every second channel). Alternatively, the spacers could be placed inside the air supply channels.

To form the separate macro-chambers 9150, 9152, 9154, 9156 of compression garment 9004, the intermediate layer 9200 can be welded or otherwise secured to create a boundary line between the macro-chambers. For example, a boundary weld line 9151 along intermediate layer 9200 and bottom layer 9100 between macro-chambers 9150, 9152 forms a separation boundary to aid in forming the macro-chamber 9150. Similar boundary weld lines 9153, 9155 between macro-chambers 9152, 9154, 9156 can be applied to aid formation of the macro-chambers 9152, 9154, 9156.

To form the air channels 9010, 9020, 9030, 9040, the top layer 9300 and intermediate layer 9200 are also welded or otherwise secured (e.g., adhesive bonding) along air channel boundary lines 9016, 9026, 9036, 9046. The air supply channels 9010, 9020, 9030, 9040 extend from the valve spine interface arrangement 9008 to corresponding pneumatic connectors 9012, 9022, 9032, 0942 that are further pneumatically connected to the macro-chambers 9150, 9152, 9154, 9156. In some implementations, the air channels 9010, 9020, 9030, 9040 extend from valve connectors 9014, 9024, 9034, 9034 positioned at the valve spine arrangement 9008 to the pneumatic connectors 9012, 9022, 9032, 9042 that are connected to the respective macro-chambers 9150, 9152, 9154, 9156. As depicted in FIGS. 9A to 9C, the air supply channels 9010, 9020, 9030, 9040 are positioned above the macro-chambers 9150, 9152, 9154, 9156 to occupy that same overall foot-print of the compression garment 9008. In some implementations, such as depicted in FIGS. 9B and 9C, a macro-chamber, such as macro-chamber 9156, can be subdivided into a plurality of micro-chambers 9156a-k within the independent macro-chamber 9156.

In some implementations, the air supply channels 9010, 9020, 9030, 9040 are pneumatically connected to the valve spine arrangement 9008 with a dedicated valve connector for each air supply channel. In some implementations, more than one air supply channel 9010, 9020, 9030, 9040 is pneumatically connected to a single connector in the valve spine arrangement 9008. In some implementations, the air supply channels 9010, 9020, 9030, 9040 extend into the valve spine arrangement 9008 and are directly connected to the chamber valves. In some implementations, one or more of the air supply channels 9010, 9020, 9030, 9040 may have a short tube welded, or otherwise bonded, at the valve spine arrangement side of the air supply channel that provides a rigid or semi-rigid extension that connects to a valve chamber in the valve spine arrangement 9008.

In some implementations, the air supply channels are generally airtight with micro-penetrations in the intermediate layer 9200 that allow a controlled leak of air that is further allowed to diffuse through the bottom layer 9100 adjacent to the skin of the user to provide a cooling or drying effect on the user's limb.

In some garment manufacturing processes, such as RF welding, because of the shared intermediate layer, the formation of the air supply channels and their boundary lines may interfere with that of the macro-chambers. One desirable implementation can include forming the air supply channels and the macro-chambers in different, non-overlapping, areas of the garment. Another desirable implementation can include a four-layer system. Referring to FIGS. 10A, 10B-1 and 10B-2, exemplary exploded perspective and cross-sectional schematic views are depicted of a four-layer compression garment 10004. Air supply channels 10010, 10020, 10030, 10040 are formed between layers 10300, 10400 of the four-layer compression garment 10004. The four-layer compression garment 10004 can be advantageous for creating air supply channels in a compression garment for supplying pressurized air from pneumatically connected chamber valves (see FIGS. 3 to 7) of a valve spine interface arrangement 10008, similar to the valve spine arrangements 1008, 3008, 4000a, 4000b, 5008, 6008, 7008 described in FIGS. 1 to 7. A four-layer system can minimize some of the less desirable aspects of a three-layer compression garment such as fabrication issues with having a shared layer. In addition, a four-layer system can minimize mechanical interference between the air supply channels and the macro/micro-chambers during pressurisation and depressurisation of the compression garment 10004, by eliminating a shared layer in the forming of the air supply channels and the macro-chambers.

In some implementations, the four-layer compression garment 10004 includes two layers (e.g., upper intermediate layer 10300, top layer 10300) dedicated to forming the air supply channels 10010, 10020, 10030, 10040. A separate bottom layer 10100 (e.g., layer closest to skin) and a lower intermediate layer 10200 are dedicate to forming a plurality of macro-chambers 10150, 10152, 10154, 10156 for the compression garment 10004.

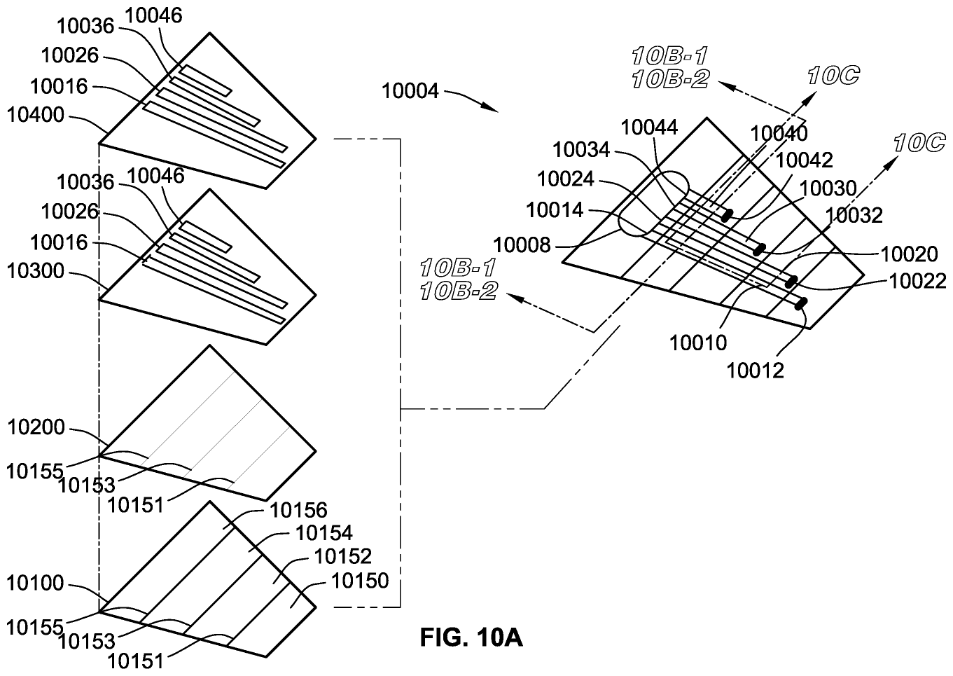

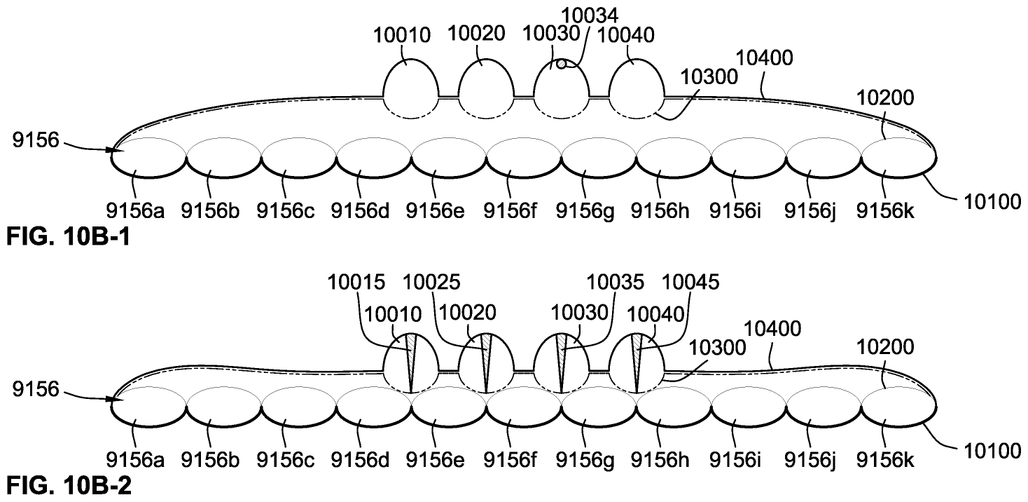

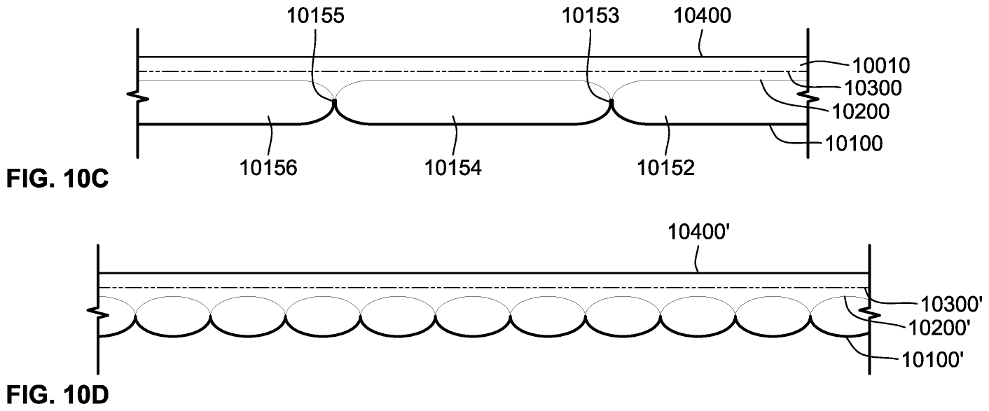

In some implementations, the air supply channels 10010, 10020, 10030, 10040 formed between the upper intermediate layer 10300 and top layer 10400 can include structural supports (e.g., over-weld lines, ribs, or spacers) extending in the top layer 10400, or within the air supply channel itself, along the longitudinal axis of the air supply channels to provide some rigidity to an air supply channel. The added rigidity aids in minimizing closure of an air supply channel during use of the compression garment during compression therapy. An example of a longitudinal structural rib (e.g., in the form of a weld line 10034) is provided in FIG. 10B-1 for air supply channel 10030 and an example of alternate longitudinal ribs 10015, 10025, 10035, 10045 are depicted in FIG. 10B-2 for air supply channels 1010, 10020, 10030, 10040. One or more structural ribs, similar to longitudinal structural ribs 10015, 10025, 10034, 10035, 10045 can be included in each air supply channel 10010, 10020, 10030, 10040. It is further contemplate that structural ribs could also be positioned along the top of the air supply channels 10010, 10020, 10030, 10040, or in the top layer 10400, that are transverse to the longitudinal axis of the air supply channel 10010, 10020, 10030, 10040. Other forms of structural support for the air supply channels may include spacer(s) (not shown) distributed at least along a portion of the length of one or more channels (e.g., every second channel). Alternatively, the spacers could be placed inside the air supply channels.

To form the separate macro-chambers 10150, 10152, 10154, 10156 of compression garment 10004, the lower intermediate layer 10200 can be welded or otherwise secured (e.g., heat bonded) to create a boundary line between the macro-chambers. For example, with reference to FIG. 10A, a boundary weld line 10151 along lower intermediate layer 10200 and bottom layer 10100 forms macro-chamber 10150, as well as a boundary between macro-chambers 10150 and 10152. Similar boundary weld lines 10153, 10155 can be applied to aid formation of the macro-chambers 10152, 10154, 10156.

To form the air channels 10010, 10020, 10030, 10040, the top layer 10400 and upper intermediate layer 10300 are also welded or otherwise secured (e.g., heat bonded) along air channel boundary lines 10016, 10026, 10036, 10046 that extend parallel to the longitudinal axis of each air supply channel. In some implementations, the air channels 10010, 10020, 10030, 10040 extend from valve connectors 10014, 10024, 10034, 10034 positioned at the valve spine arrangement 10008 to the pneumatic connectors 10012, 10022, 10032, 10042 of the respective macro-chambers 10150, 10152, 10154, 10156. As depicted in FIGS. 10A, 10B-1, and 10C, the air supply channels 10010, 10020, 10030, 10040 are positioned directly above the macro-chambers 10150, 10152, 10154, 10156 to occupy that same overall foot-print of the compression garment 10008. In some implementations, such as depicted in FIGS. 10B-1 and 10B-2, one or more macro-chambers, such as macro-chamber 10156, can be subdivided into a plurality of micro-chambers 10156a-k within the independent macro-chamber 10156.

In some implementations, the air supply channels 10010, 10020, 10030, 10040 are pneumatically connected to the valve spine arrangement 10008 with a dedicated valve connector for each air supply channel. In some implementations, more than one air supply channel 10010, 10020, 10030, 10040 is pneumatically connected to a single connector in the valve spine arrangement 10008. In some implementations, the air supply channels 10010, 10020, 10030, 10040 extend into the valve spine arrangement 10008 and are directly connected to the chamber valves. In some implementations, one or more of the air supply channels 10010, 10020, 10030, 10040 may have a short tube welded at the valve spine arrangement side of the air supply channel that provides a rigid or semi-rigid extension that connects to a valve chamber in the valve spine arrangement 10008.

In some implementations, the air supply channels are generally airtight with micro-penetrations in the upper intermediate layer 10200 that allow a controlled leak of air that is further allowed to diffuse through the lower intermediate layer 10200 and the bottom layer 10100 adjacent to the skin of the user to provide a cooling or drying effect on the user's limb. Alternatively, the micro-air penetrations may be placed directly on the bottom layer 10100 adjacent to the skin of the user, to provide a cooling or drying effect (e.g., as the chambers inflate, the micro-penetrations will allow some controlled level of airflow onto the skin surface).

In some implementations, the top layer 10400 and the upper intermediate layer 10300 that form the air supply channels 10010, 10020, 10030, 10040 may be separated or float above the lower intermediate layer 10200 that forms the macro-chambers 10150, 10152, 10154, 10156, as depicted in FIG. 10B-1. In some implementations, the top layer 10400 and the upper intermediate layer 10300 that form the air supply channels 10010, 10020, 10030, 10040 may rest on the lower intermediate layer 10200 that forms the macro-chambers 10150, 10152, 10154, 10156, as depicted in FIG. 10B-2

Referring to FIG. 10C, a partial exemplary cross-sectional view, along cross-section in FIG. 10A, of the compression garment 10004 is depicted for a cross-section, along air supply channel 10010 and across macro-chambers 10152, 10154, 10156, formed between layers 10400, 10300, 10200, 10100 of the four-layer compression garment 10004. The weld boundaries 10153, 10155 (e.g., heat bonds) between macro-chambers 10152, 10154, 10156 aid with forming the macro-chambers.

In the example depicted in FIG. 10A, air supply channels 10010, 10020, 10030, 10040 extend transversely to macro-chambers 10150, 10152, 10154, 10156. In other implementations, air supply channels may be formed to extend in parallel to the macro-chambers. As depicted in illustrative cross-section FIG. 10D, a series of micro-chambers within a single macro-chamber (similar to the cross-sections in 10B-1 and 10B-2) are formed between bottom layer 10100′ and the lower intermediate layer 10200′. An air supply channel is formed between upper intermediate layer 10300′ and top layer 10400′ that extends in a direction parallel to the macro-chambers, or perpendicular to the air supply channels 10010, 10020, 10030, 10040 depicted in FIG. 10A.

In some implementations, compression garments, such as compression garments 90004 and 10004, are used to implement circulatory-related disorder therapy. The compression garments may include an inner layer (e.g., bottom layers 9100, 10100), an outer layer (e.g., top layers 9300, 10400, and one or more intermediate layers (e.g., intermediate layer 9200, lower intermediate layer 10200, upper intermediate layer 10300). The intermediate layer(s) are positioned between the inner layer and the outer layer. One or more independently pressurizable macro-chambers (e.g., macro-chambers 9150, 9152, 9154, 9154, 10150, 10152, 10154, 10156) are integrally formed between any two layers on the inner layer facing side of the intermediate layer. Each macro-chamber is configured to receive pressurized air. One or more air supply channels (e.g., air supply channels 9010, 9020, 9030, 9040, 10010, 10020, 10030, 10040) are integrally formed within the garment between any two layers on the outer layer facing side of the intermediate layer. The one or more air supply channels are configured to supply pressurized air to a respective one of the one or more independently pressurized macro-chambers. One or more valves are each pneumatically connected to an air supply channel and to one or more independently pressurizable macro-chambers. The one or more valves are configured to supply pressurized air to the one or more independently pressurizable macro-chambers.

In some implementations of the compression garments, such as compression garments 9004, 10004, one of the any two layers includes the intermediate layer.

In some implementations of the compression garments, such as compression garments 9004, 10004, one of the any two layers on the inner layer facing side includes the inner layer.

In some implementations of the compression garments, such as compression garments 9004, 10004, one of the any two layers on the outer layer facing side includes the outer layer.

In some implementations of the compression garments, such as compression garment 9004, the compression garment is a three-layer garment including the inner layer, the outer layer, and the intermediate layer. The one or more independent pressurizable macro-chambers are formed between the inner layer and the intermediate layer, and the one or more air supply channels are integrally formed between the outer layer and the intermediate layer.

In some implementations of the compression garments, such as compression garments 9004, 10004, the independently pressurizable macro-chambers and the air supply channels are formed in the same area of the garment.

In some implementations of the compression garments, such as compression garments 9004, 10004, the one or more of the independently pressurizable macro-chambers overlap at least a portion of the one or more of the air supply channels.

In some implementations of the compression garments, such as compression garments 9004, 10004, the one or more air supply channels are formed along seams separating at least two of the one or more independently pressurizable macro-chambers.

In some implementations of the compression garments, such as compression garments 9004, 10004, the any two layers forming an air supply channel include airtight materials.

In some implementations of the compression garments, such as compression garments 9004, 10004, one or more connectors are disposed on the outer layer, and each of the one or more connectors are connected to one or more air supply channels.

A circulatory-related disorder therapy system, such as compression therapy systems 1000, 3000a, 3000b, 3000c, can include a compression garment, such as compression garment 9004, 10004 as described for FIGS. 9 and 10, along with a CPG device for generating pneumatic pressure for pressurizing the one or more independently pressurizable macro-chambers via the one or more air-supply channels, along with a controller and a controller device. The controller can include one or more processors and is configured to control operation of the CPG device in a therapy process to generate pneumatic pressure in the plurality of chambers of the compression garment during a therapy period. The control device includes one or more processors and a computer readable medium having processor control instructions, that when executed by at least one of the one or more processors of the control device, cause the control device to receive, from the controller, a parameter relating to the therapy process. In some implementations, the control device is a mobile phone or a tablet computer. In some implementations, the control device can be the CPG device. In some implementations, the processor control instructions further cause the control device to (i) present a graphical user interface on a display of the control device; (ii) receive, through the graphical user interface, a command from a user, the command being configured, when received, to cause the controller to change the operation of the compression pressure generator in the therapy process; and (iii) transmit, to the controller, the received command. In some implementations, the compression garment further includes one or more valves each pneumatically connected to an air supply channel and to one or more independently pressurizable macro-chambers. The one or more valves supply pressurized air to the one or more independently pressurizable macro-chambers. In some implementations, the controller can further be configured to selectively control operation of the main air supply valve and the plurality of chamber valves.

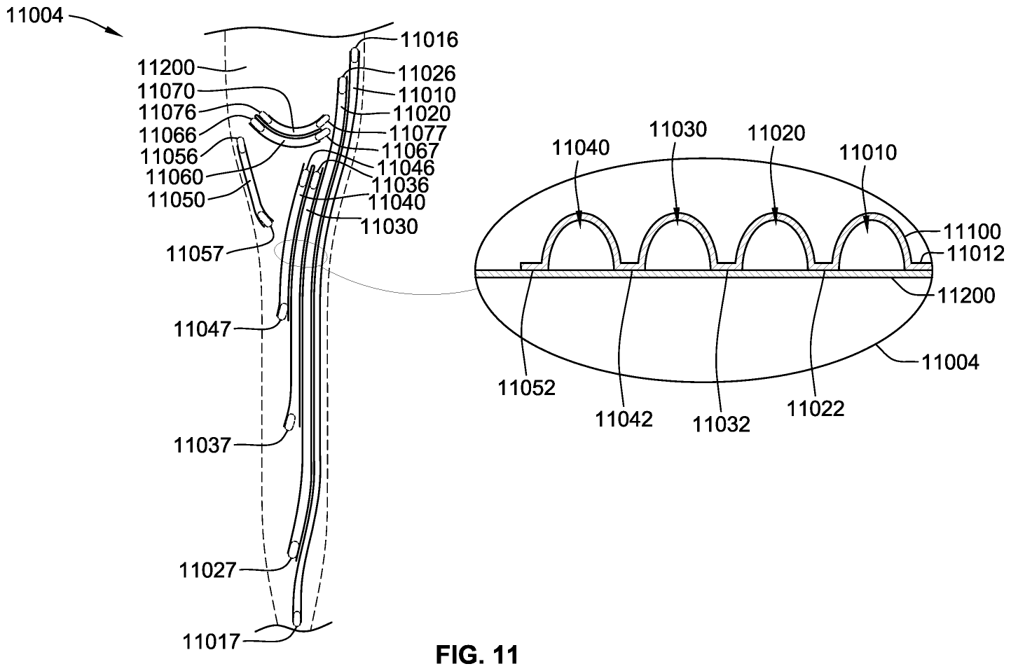

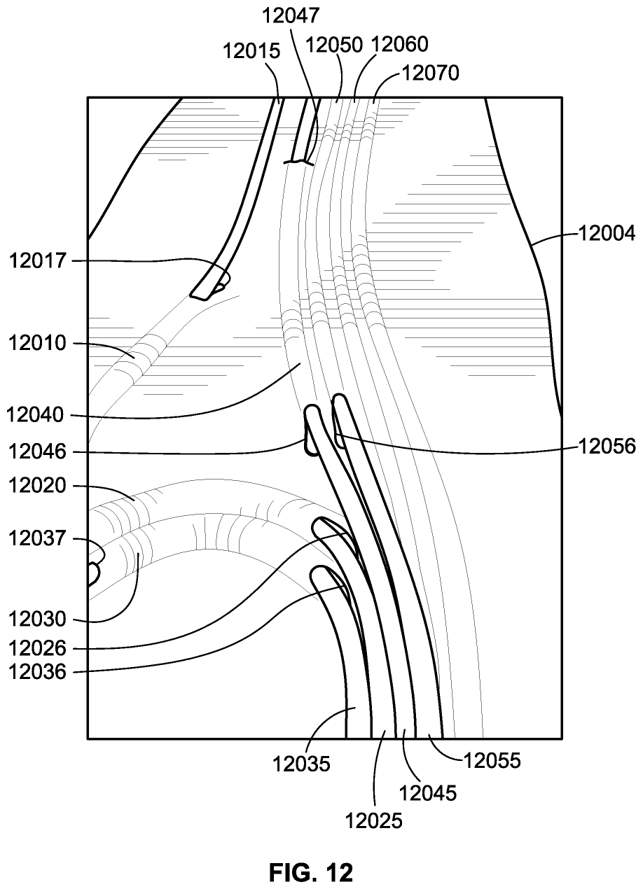

Turning now to FIG. 11, a schematic top partial cross-sectional view of a compression garment 11004, including exemplary tube guides 11010, 11020, 11030, 11040, 11050, 11060, 11070, is depicted, along with a partial transverse cross-sectional view of the tube guides 11010, 11020, 11030, 11040, 11050, 11060, 11070. Referring to FIG. 12, a partial top perspective view of an implementation of a compression garment 12004, similar to compression garment 11004, is depicted illustrating engaged air supply tubes extending through exemplary tube guides 12010, 12020, 12030, 12040, 12050, 12060, 12070. Tube guides can be particularly advantageous because they maintain their respective air supply tubes on a predetermined pathway, which prevents the air supply tubes from becoming entangled with one another or with other components of a compression garment. In some implementations, the tube guides receive, guide, and/or restrain the air supply tubes to further minimize the dislodging of the air supply tubes. In some implementations, the tube guide further can protect an air supply tube from being damaged (e.g., kinked, bent, cut). The air supply tubes extend from a compression garments valve spine arrangement or other electronic valve control systems to the air chambers of the compression garment, such as independently pressurizable macro-chambers to allow air to enter and exit the air chambers.

Air supply tubes for a compression therapy system include a number of relatively long tubes (e.g., a central air supply tube, or air supply tubes connecting each chamber valve with a respective chamber). In some implementations, tube guides can be beneficial for guiding the tubes along their path during initial insertion, and in some implementations, to also restrict their movement and keep them reliably located in their intended position. Such an arrangement is desirable as it streamlines tube management within the compression garment and minimizes the possibility for any unguided and/or miss-positioned tubing to kink and/or get disconnected from the respective valves, such as at the valve spine interface, or from compression garment inlet connectors.

Referring to both FIGS. 11 and 12, exemplary aspects of tube guides are depicted where two layers of the compression garment are bonded or welded together along large areas of the garment surface, except for a number of thin strips, one along the length of each tube, as well as the end openings at the end of each of the tube guides, where air supply tubes enter and exit the tube guides. The compression garment 11004, 12004 can include one or more independently pressurizable macro-chambers (not shown), such as the chambers for compression garments 1004, 3004, 9004, 10004, 13004 described in FIGS. 1, 2, 3, 9A, 10A, and 13) where each macro-chamber is configured to receive pressurized air. One or more air supply tubes (e.g., tubes 12015, 12025, 12035, 12045, 12055 in FIG. 12) are configured to supply pressurized air to a respective one of the one or more independently pressurized macro-chambers. In some implementations, the tube guides are fabricated using TPU or other comparable materials. Each tube guide 11010, 11020, 11030, 11040, 11050, 11060, 11070, 12010, 12020, 12030, 12040, 12050, 12060, 12070 is configured to maintain a corresponding one of the one or more air supply tubes (e.g., tubes 12015, 12025, 12035, 12045, 12055) on a predetermined pathway in or on the compression garment 11004, 12004. One or more valves (not shown), as discussed elsewhere such as for FIGS. 1-7, may each be pneumatically connected to an air supply tube and, via the tube, to at least one of the one or more independently pressurized macro-chambers. The one or more valves are configured to supply pressurized air to one or more independently pressurizable macro-chambers. The one or more tube guides (e.g., 11010, 11020, 11030, 11040, 11050, 11060, 11070, 12010, 12020, 12030, 12040, 12050, 12060, 12070) define predetermined pathways to or from one or more valves, and/or to or from one or more independently pressurized macro-chambers.

As depicted in FIGS. 11 and 12, one or more of the tube guides, such as tube guides 11010, 11020, 11030, 11040, 11050, 11060, 11070, 12010, 12020, 12030, 12040, 12050, 12060, 12070, can be formed integrally with the compression garment, such as compression garment 11004, 12004. As depicted in the transverse cross-sectional view of FIG. 11 for tube guides 11010, 11020, 11030, 11040, the tube guides can be formed by a tube guide layer 11100 of fabric or textile material attached to a boundary layer 11200. In some cases, the tube guides can be formed by a single layer, such as where a single layer is folded back on itself to serve as both layers 11100 and 11200 of FIG. 11. In some implementations, one or more tube guides can be formed by a layer on an inner side of a compression garment. The layer 11100 forming the tube guides can be welded or otherwise adhered to the outer boundary layer 11200 at the seams defining the longitudinal boundaries of the tube guides, such as seams 11012, 11022, 11032, 11042, 11052. In some implementations, the seam may be a double weld, such as between two tube guides and in some implementations the seam may be a single weld, such as where a tube guide boundary is not immediately adjacent to another tube guide.

In some implementations, the tube guides include end openings on either or both ends of the tube guides. Examples of such end openings include end openings 11016, 11017, 11026, 11027, 11036, 11037, 11046, 11047, 11056, 11057, 11066, 11067, 11076, 11077, 12017, 12026, 12036, 12037, 12046, 12047, 12056 (FIGS. 11 and 12). When the garment is set up, each tube is usually inserted into the respective tube guide via a respective opening. The tube guides maintain the inserted air supply tubes on the predetermined pathway created by the tube guides. In some implementations, the tube guides may be fabricated in, rather than being inserted into the tube guides such as through an end opening. The end openings of a tube guide aid with channeling the tube guides and can be positioned anywhere along a tube guide, as needed to direct an air supply tube.

In some implementations, a compression garment, such as compression garment 1004, 3000a, 3000b, 3000c, 9004, 10004, 13004, can include a pocket for housing an air control assembly that is pneumatically coupled with one or more valves, such as chamber valves, exhaust valves, and main air supply valves.

In some implementations, a compression garment, such as compression garment 1004, 3000a, 3000b, 3000c, 9004, 10004, 13004, can include at least one of (a) one or more independently pressurized macro-chambers, (b) one or more of the tube guides, or (c) a pocket formed between the outer layer and a second layer of the compression garment.

In some implementations, a compression garment, such as compression garment 1004, 3000a, 3000b, 3000c, 9004, 10004, 13004, the pocket can include at least a portion of one or more of the tube guides. In some implementations, the air control assembly may be a pneumatic spine, similar to the valve spine arrangements 3008, 4000a, 4000b, 5008, 6008, 7008 depicted in FIGS. 3 to 7, that is included in the pocket. In some implementations, the one or more valves can include chamber valves, exhaust valves, and main air supply valve, as a part of the pneumatic spine. In some implementations, the one or more valves are located remotely from the pneumatic spine. In some implementations, two or more of the one or more valves are distributed at multiple dispersed locations of the compression garment.

In some implementations in a compression garment, such as compression garment 1004, 3000a, 3000b, 3000c, 9004, 10004, 13004, the one or more valves can be arranged in two rows in close proximity to each other, such as depicted in FIGS. 4A, 5, 6, and 7. In some implementations, the one or more valves can be arranged in a single row, such as depicted in FIG. 4B. Other arrangements are contemplated, as well.

The one or more of the tube guides 11010, 11020, 11030, 11040, 11050, 11060, 11070 depicted in FIG. 11 are illustrated as guides that can receive air supply tubes, such as tubes 12015, 12025, 12035, 12045, 12055 depicted in FIG. 12. However, in some implementations where the tube guides are fabricated to be substantially airtight, one or more of the tube guides may act as air supply channels, similar to the air supply channels described for FIGS. 9A, 9B, 10A, and 10B, the tube guides are also the air channels and/or air supply tubes.

In some implementations, airtight air supply channels, air supply tubes, tube guides, or combinations thereof, can be integrated into a base structure of a compression garment, or included as an additional layer within the compression garment while still integral to the compression garment operation. The materials used for forming the channels, tubes, and/or guides can include textiles with thermoplastic film backing that may be bonded or welded or include silicone thermoplastic films that may or may not include a fabric, depending on the implementation. In some implementations, it can be advantageous to have a combination of air supply tubes and tube guides in certain sections of the compression garment and air supply channels in other parts (e.g. having tubes and tube guides in areas where there is repetitive bending, such as at the knee or other joint, and airtight air supply channels in areas, such as along the calf or thigh where there is minimal bending).

A circulatory-related disorder therapy system, such as compression therapy systems 1000, 3000a, 3000b, 3000c, can include a compression garment, such as compression garment 11004, 12004 as described for FIGS. 11 and 12, along with a CPG device for generating pneumatic pressure for pressurizing one or more independently pressurizable macro-chambers via the one or more air-supply channels, along with a controller and a controller device. The controller can include one or more processors and is configured to control operation of the CPG device in a therapy process to generate pneumatic pressure in the plurality of chambers of the compression garment during a therapy period. The control device includes one or more processors and a computer readable medium having processor control instructions, that when executed by at least one of the one or more processors of the control device, cause the control device to receive, from the controller, a parameter relating to the therapy process. In some implementations, the control device is a mobile phone or a tablet computer. In some implementations, the processor control instructions further cause the control device to (i) present a graphical user interface on a display of the control device; (ii) receive, through the graphical user interface, a command from a user, the command being configured, when received, to cause the controller to change the operation of the compression pressure generator in the therapy process; and (iii) transmit, to the controller, the received command. In some implementations, the controller can further be configured to selectively control operation of the main air supply valve and the plurality of chamber valves.

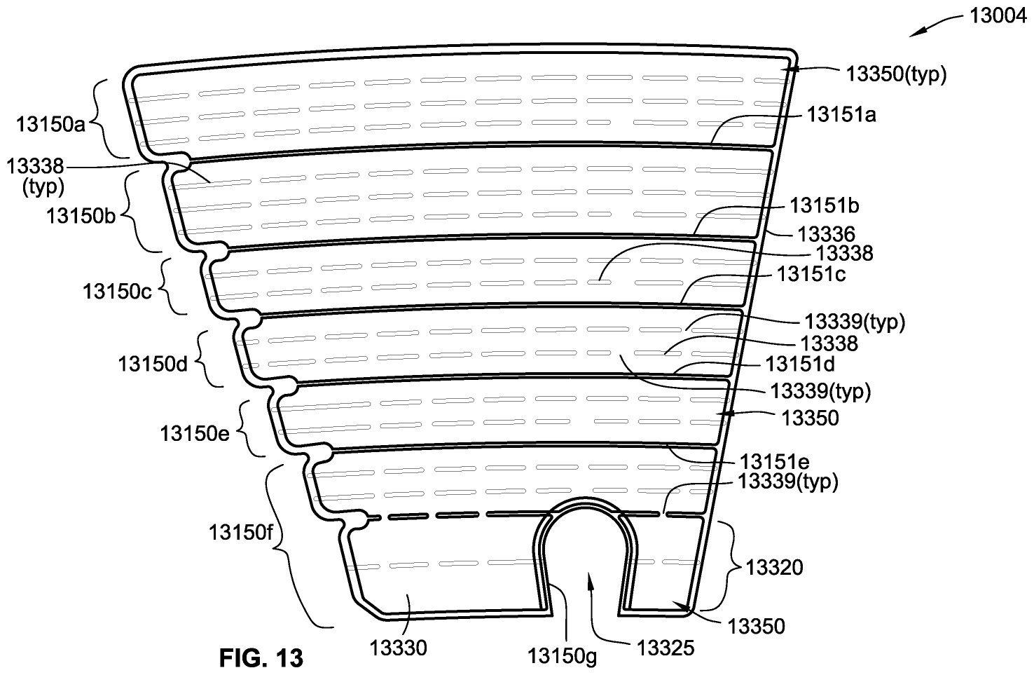

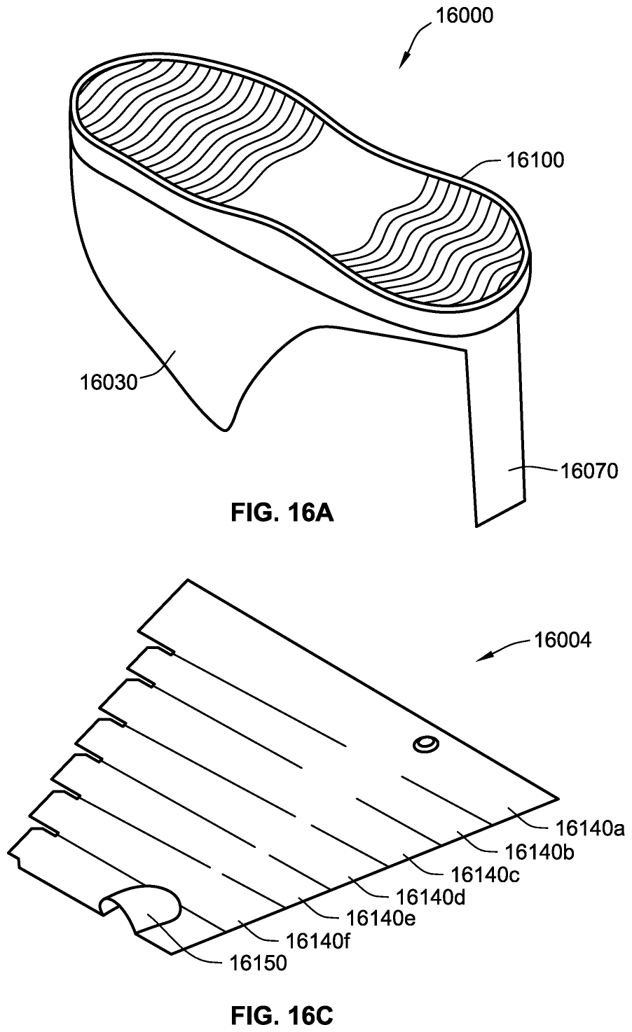

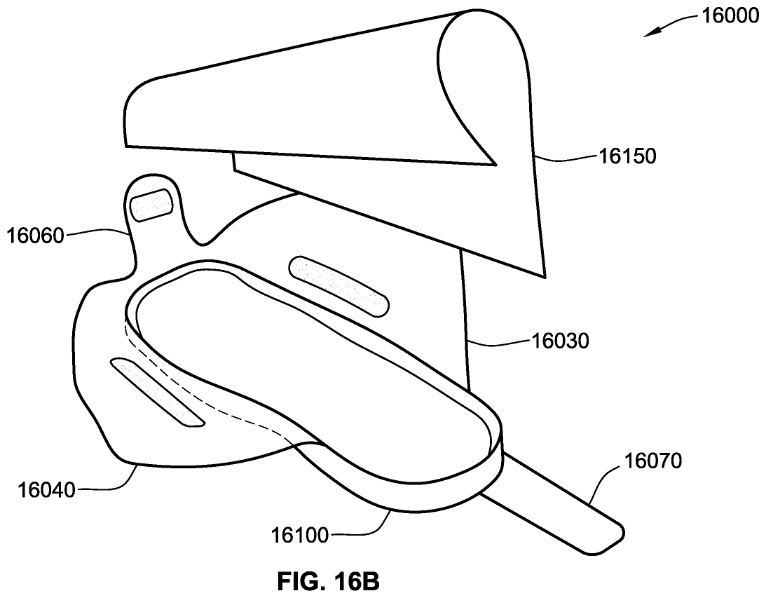

Referring now to FIG. 13, a flattened top cross-sectional view of an exemplary leg and/or a partial foot compression garment is depicted including macro-chambers and micro-chambers within the macro-chambers. An exemplary weld profile based on welds 13336, 13151a-e is disposed on a skin contacting layer 13330 of the compression garment 13004. The exemplary weld profile defines a plurality of independently pressurizable macro-chambers that in some implementations, can include a plurality of micro-chambers. The weld profile 13336, 13151a-e and skin contacting layer 13330 include welds 13336, 13151a-e that couple the skin contacting layer 13330 to a second layer (not shown) disposed above the skin contacting layer 13330 and together form air-tight boundaries of the transverse independently pressurizable macro-chambers 13150a-g. The skin contact layer 13330 of the compression garment 13004 includes exemplary welds, such as perimeter weld 13336 at the outermost boundary of the skin contact layer 13330 and shared transverse macro-chamber welds 13151a-e defining the boundary between the adjacent independent macro-chambers 13150a-g. The perimeter welds 13336 and shared transverse macro-chamber welds 13151a-e are solid or continuous with no openings so as to prevent or minimize the passage of air outside of a welded macro-chamber or between macro-chambers. These continuous welds define the outer edge of each of the plurality of macro-chambers 13150a-g. The macro-chamber 13150g protrudes outwardly from FIG. 13 and is dedicated to compression therapy of a user's foot, similar to foot-section 16150 in FIG. 16B. In some implementations, macro-chamber 13150g may also be an extension of macro-chamber 13150f.

Varying layouts or arrangements of typical micro-welds 13338 are contemplated in the macro-chambers 13150a-g. The micro-welds 13338 define separate interconnected transverse micro-chambers 13350 within the macro-chambers 13150a-g. The micro-welds 13338 can be modified in length to customize the pressure and treatment density for a particular circulatory-related disorder. Openings or gaps 13339 created by discontinuous micro-welds 13338 can be positioned to control the expansion and direction of air through the macro-chambers 13150a-g and their corresponding micro-chambers 13350.

In some implementations, the exemplary compression garment 13004, based on the pattern of skin contacting layer 13330, is one-piece where a foot section 13320 extends from the macro-chamber 13340f and includes an opening 13325 define by macro-chamber 13150g that extends outwardly for implementing therapy to the top of the foot and allows the foot section 13320 to be wrapped about the user's foot.

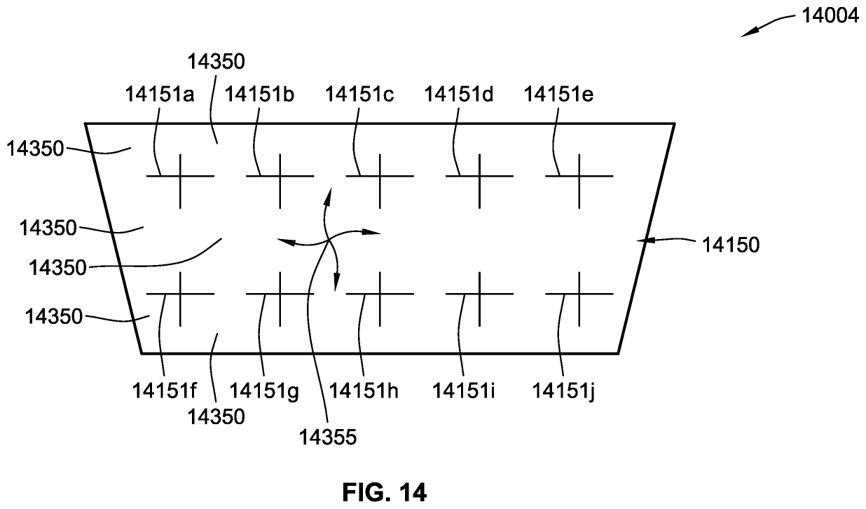

Referring now to FIG. 14, a top cross-sectional view of an exemplary compression garment 14004 for a foot is depicted, including welded seams 14151a-j that subdivide macro-chamber 14150 into a plurality of micro-chambers 14350. In some implementations, the macro-chamber 14150 and micro-chambers 14350 of the compression garment 14004 have various polygonal shapes, such as square, rhomboidal, or rectangular. In some aspects, the macro-chamber 14150 or micro-chamber 14350 may also be arc-shaped, circular, or elliptical. In the exemplary aspect of the compression garment 14004 the welded seams 14151a-j run both parallel to the longitudinal axis of the macro-chamber 14150 and perpendicular to the longitudinal axis. In the exemplary aspect of FIG. 14, the weld seams are in the shape of “+” signed or crosses. It is contemplated that in some implementations the weld seams can run both parallel, perpendicular, or skew to the longitudinal axis of the macro-chamber 14150, and can be independent of each other where at least some weld seams do not intersect.

While the macro-chambers 13150 of FIG. 13 are elongated, in some implementations, a macro-chamber can be subdivided into non-elongated micro-chambers, such as micro-chambers 14350 (FIG. 14), having square-like areas, interlinked with airflow channels (e.g., the gaps 14355 between the crosses of weld seams 14151a-j indicating open areas allowing airflow). When pressurized air is introduced into the macro-chamber, air flows from one end of the macro-chamber (pressurised by the air delivered by the attached air channel) to the other end and is able to move from each micro-chamber to adjacent micro-chambers through the airflow micro-channels interlinking the micro-chambers. By constraining the volume of the micro-chambers of the macro-chamber into square-like areas, a more uniform overall distribution of air may be achieved. It is advantageous where the micro-channels linking adjacent micro-chambers extend in more than one direction, such as in the case of FIG. 14, where micro-channels (e.g., channels between micro-chambers) extend in at least two transverse directions.

In some implementations, it is contemplated that the introduction of macro- and/or micro-chambers of specific structure in a compression garment, such as an ankle chamber or a foot chamber, can allow the respective specific macro/micro-chamber to better target, and thereby improve, treatment of a specific limb area. The contemplated compression garment can have the ability to fit and/or pressurize/massage a limb with a different spatial resolution and pressurization pattern provided by the numerous micro-chambers in a specific area of the compression garment, as described for example for FIGS. 13 and 14. Having a specific shape of the macro/micro-chambers and/or the interlinkage pattern among them can adjust their limb application, applied pressure distribution, size, the time they are pressurised for, and the way they interface with the contours of a user's limb. In some implementations, it may be desirable to have an ankle or foot chamber with large rectangular cells, because of the capability of such cells to wrap better around to limb. Such an arrangement can be beneficial in the areas of the ankle and behind the knees of a user, where fluid accumulation can vary for the same user over time and/or across users, causing a large variation in the quality of the fit of the garment not only between users, but also for the same user, depending on the swelling of the limb. In another arrangement, it may be desirable to have one or more macro-chambers with a rectangular, square or a parallelogram-like micro-chamber system to allow for a better spatial resolution. It is contemplated that the deflation behaviour of the ankle or foot chamber is also influenced by the shape and size of the micro-chambers, along with the internal location within the macro-chamber of airflow gaps between micro-chambers.

Another advantageous outcome of the selection of a specific type of macro/micro-chambers, is the mitigation of non-uniform inflation and/or deflation of the compression garment. As depicted, for example, in FIG. 13, macro-chambers of a compression garment, such as compression garments 1004, 13004, are generally defined by horizontal weld lines that delineate a plurality of elongated macro chambers, such as macro-chambers 3150a-f. Such arrangements of macro-chambers can in some implementations cause non-uniform inflation and/or deflation, especially in the more remote areas of the compression garment, such as the ankle or foot areas. In some implementations, to address the issue of non-uniform inflation and/or deflation, compression garments with multiple air macro-chambers, such as compression garment 13004, can further include a dedicated ankle or foot chamber, with generally square or rectangular macro-chambers, such as macro-chamber 14150 (see FIG. 14), rather than elongated rectangular macro-chambers. The generally square or rectangular macro-chambers are interconnected with wider interconnecting channels to allow more free movement of air into and out of the channels between the micro-chambers of the ankle of foot portion of the compression garment. The generally square or rectangular macro-chambers configuration can advantageously allow more uniform deflation of the ankle or foot chamber by providing better air flow between the micro-chambers, such as micro-chamber 14350, and an improved distribution of the volume of air across the micro-chambers than would be otherwise be provided by elongated rectangular chambers.

In some implementations, one or more macro-chambers, such as macro-chamber 14150 of FIG. 14) may be formed as a standalone compression garment, or a portion of garment, that can be combined with other macro-chambers (garment portions) in a modular fashion. In some aspects, an ankle macro-chamber (with associated micro-chambers) can be combined with a foot and a calf macro-chamber that together form a compression garment for the lower leg. In another aspect, a foot, ankle, calf, knee and trunk macro-chamber can be combined to form a compression garment for a lower limb.

In some implementations, instead of the generally parallel seam lines shown in FIG. 13, for a more uniform air distribution, a restricted weld seem arrangement, such as that described for FIG. 14, may be used, where for example, vertical (perpendicular to the original) weld lines, are added to the previous horizontal ones, defining interconnected micro-chambers of generally rectangular or square shapes. In some implementations, non-parallel lines can also be used to define an arrangement of micro-chamber within a macro-chamber where the weld seams are in, rhomboidal, trapezoidal or other arrangements. At least one, more than one, or all of the defined micro-chambers may be interconnected with each of their adjacent micro-chambers. Curved lines and shapes can also be used. It is contemplated that the application of such curved or contour shape welds to create the micro-chambers, in a generally square or rectangular macro-chamber, provides improved conformity of the compression garment to certain sections of a limb or body anatomy, e.g. a circular arrangement could be applied around the toes, given the size and geometry of the toes whilst a more traditional rectangular shape may be appropriate around the upper foot.

According to some implementations, a compression garment for circulatory-related disorder therapy includes a skin contacting layer and at least one second layer, at least one of the at least one second layers being coupled to the skin contacting layer such that the skin contacting layer and the coupled second layer form at least one macro-chamber. One or more of the at least one macro-chambers can be partitioned into a plurality of micro-chambers. One or more of the plurality of micro-chambers can be in direct fluid communication with at least one other of the plurality of micro-chambers. Each macro-chamber is configured to receive pressurized air. The coupling of the skin contacting layer and the second layer includes a weld profile. The second macro-chamber includes perimeter micro-chambers and interior micro-chambers. The weld profile defines a plurality of interior micro-chambers in direct fluid communication with adjacent generally square shaped micro-chambers. In some implementations, the weld profile may define a plurality of interior micro-chamber that are non-square (e.g., rectangular, rhomboidal, parallelogram, curved etc.).

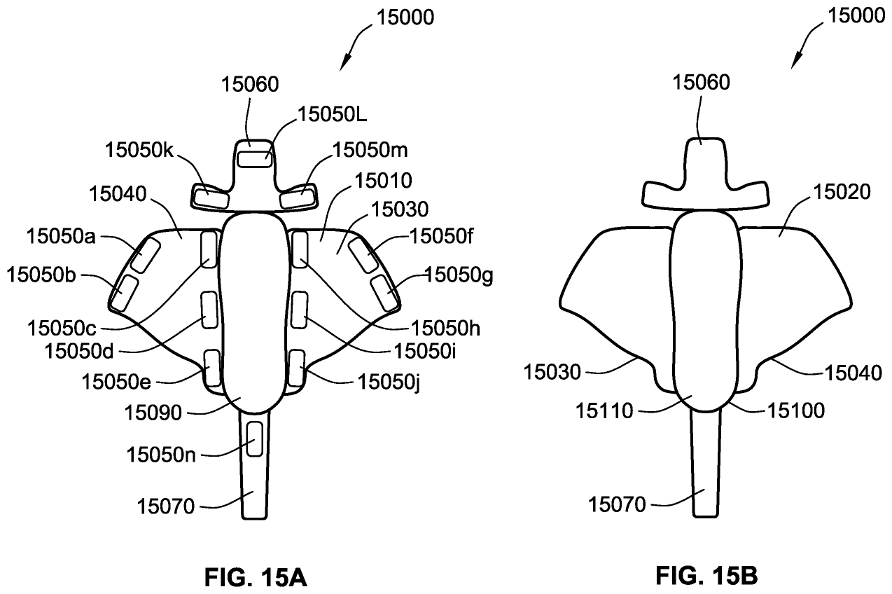

Referring now to FIGS. 15A and 15B are top and bottom views of a foot chamber support assembly 15000 that may be a standalone assembly, or be a part of a compression garment. The assembly 15000 includes fastener pads 15050a-n on interior surfaces 15010 of flexible foot wrap portions 15020a-d that wrap at least partially around a user's foot during use.

A flexible sole 15100 is attached to an exterior surface 15020 of the foot chamber support assembly 15000 as depicted in the flattened bottom view of FIG. 15B. The flexible foot sole 15100 may be secured to the foot chamber support assembly 15000 using an adhesive adhered, for example, to an exterior side of support assembly base 15090 or RF welded directly. In some implementations, the flexible sole 15100 is fabricated from a neoprene material. In some implementations, the flexible sole 15100 may be fabricated from a semi-rigid material.

The foot chamber support assembly 15000 includes wrapping portions 15030, 15040 for securing the assembly 15000 about the sides and top of the user's foot during use. In addition, a toe loop 15060 and a heel loop 15070 further secure the foot chamber support assembly 15000 at the front and back of the user's foot. The fastener pads 15050a-n are positioned at multiple positions on the interior surface 15010 of the wrapping portions 15030, 15040, the toe loop 15060, and the toe loop 15070 that overlap with other surface of the foot chamber support assembly 15000 to secure the assembly 15000 to the user's foot. The wrapping portions 15030, 15040, toe loop 15060, and toe loop 15070 are fabricated from flexible conformal material that allow for an adjustable snug fit of the foot chamber support assembly 15000 about a user's foot.

The flexible outer sole 15100 provides support within the foot chamber support assembly 15000 for both the one or more pressurization foot chambers, as well as for the user's foot itself to allow the user to walk during compression therapy while wearing a leg compression garment. The flexible sole 15100 is bendable in one or both a horizontal plane defined by a base surface 15110 of flexible sole and a vertical plane perpendicular to the horizontal plane. This flexibility allows the sole to, when a user wears the foot assembly on the user's foot, to at least partially bend up and around the peripheral edges of the foot, facilitating a good fit of the assembly. The inclusion of such a flexible sole in the assembly allows the use to walk while wearing the assembly, without the sole compromising the quality of the assembly fit.

In some implementations, the foot chamber support assembly 15000, and in particular the flexible sole 15100, is contemplated for use with a leg compression garment to allow a user to tighten the compression garment around the foot. In some aspects, the flexible sole 15100 can be fabricated from a flexible foam, rubber, or other flexible synthetic or non-synthetic materials. It is contemplated that the flexible sole can also include a flexible outer sole that allows for an easier fit for the user. A heat bonded, or a similar technique (e.g., welding), approach can be used to join the flexible sole with a fabric wrap of the foot chamber support assembly 15000, such as the fabric that may be used to fabricate support assembly base 15090. In some implementations, the foot chamber support assembly is a uni-body fabric wrap with a welded inner foam to provide cushioning for users and to allow for a heat bonding or a similar technique (e.g. welding) approach to joining the flexible outer sole.

Referring to FIGS. 16A and 16B, bottom and top perspective views of another exemplary foot chamber support assembly 16000 is depicted, including wrapping portions 16030, 16040, toe loop 16060, heel loop 16070, and a flexible outer sole 16100 coupled to the wrapping portion. FIG. 16C depicts a top perspective view of a compression garment 16004 for a leg with independently pressurizable elongated transverse macro-chambers 16140a-f and a foot-section chamber 16150. The compression garment 16004 and foot chamber support assembly 16000 can be fabricated from the same or similar materials, such a synthetic fabric in multiple layers that are bonded or adhered together (e.g., two layers bonded together). The flexible outer sole 16100 can be made of flexible neoprene, or other durable flexible materials, that allows the wrapping portions 16030, 16040, toe loop 16060, and heel loop 16070 to conform to the user's foot. In some implementations, a foot pressurisation chamber 16150 can be an integral part of the compression garment 16004. It is contemplated that, during use, the wrapping portions 16030, 16040 are configured to at least partially wrap around and overlap portions of the foot pressurization chamber 16150 to fasten or secure the foot pressurization chamber 16150 to the user's foot. In some implementations, one or more of the wrapping portions 16030, 16040, the toe loop 16060, heel loop 16070, and flexible outer sole 16100 can be separate and detachable components.

In some implementations, the foot-chamber support assemblies 15000, 16000 can be attached or connected, pneumatically and/or electrically, to a compression garment 16004 applicable to the user's leg, and compliment the overall therapy by providing one or more macro-chambers for compression therapy of the user's foot. For example, macro-chambers can be included in the wrapping portions 15030, 15040, 16030, 16040, the toe loop 15060, 16060, and/or the heel loop 15070, 16070.

In some implementations, the foot chamber support assemblies 15000, 16000 are independent devices that are an accessory component to the compression garment 16004 that aid a user with walking, moving, standing, and other mobility-related functions, while minimizing interference (e.g., the foot chamber support assembly with flexible sole provide support to a user rather than compression chamber alone) with the circulatory-disorder therapy device. The accessory component can also be integrated with the lower portion of the compression garment 16004, and continue allowing for user mobility.

In some implementations, the flexible soles 15100, 16100 provides cushioning and wear resistance for the compression garment 16004 when used for limited activity, such as standing, rather than for more active activities where arch support, heel strike cushioning, and/or toe roll may be desirable.

In some implementations, a compression garment for circulatory-related disorder therapy includes a foot section that can be wrapped at least partially around a user's foot. The compression garment includes a plurality of independently pressurizable chambers including at least one foot-section chamber that can receive pressurized air. A foot chamber support assembly, such as foot chamber support assembly 15000, 16000, supports the at least one foot-section chamber at a user's foot. At least a portion of the foot chamber support assembly, including the supporting outer sole 15100, is flexible to allow bending around a periphery of the user's foot during use to aid the foot chamber support assembly with conforming to the user's foot. In some implementations, the foot chamber support assembly and/or the supporting outer sole 15100 are flexible and are configured to extend along the entire underside of the user's foot (including at least the width and/or the length of the foot) so as to aid the user in walking while the at least one foot-section chamber of the compression garment is operably positioned on the user's foot.

In some implementations, a foot chamber support assembly, such as foot chamber support assembly 15000, 16000, is separate from the plurality of independently pressurizable chambers. The foot chamber support assembly may include a wrapping portion and a flexible sole coupled to the wrapping portion. The wrapping portion can at least partially wrap around the user's foot and secure the foot chamber assembly to the user's foot during use with a flexible sole, such as flexible sole 15100, 16100, extending along the entire underside of the user's foot.

In some implementations, a foot chamber support assembly, such as foot chamber support assembly 15000, 16000, at least partially wraps around the user's foot during use to secure the foot chamber support assembly to the user's foot. At least a peripheral portion of the flexible sole can bend around the periphery of the user's foot to allow a good fit of the support assembly to the foot. In some implementations, the bending is in both a horizontal plane defined by the flexible sole and a vertical plane perpendicular to the horizontal plane.

In some implementations, the flexible sole includes a flexible outer sole bonded to an underside surface of the foot chamber support assembly, such as foot chamber support assembly 15000, 16000. The flexible sole is flexible to allow bending around a periphery of the user's foot during use. The sole can extend along the entire length of the foot to facilitate walking.

In some implementations, a foot chamber support assembly, such as foot chamber support assembly 15000, 16000, includes a foam layer attached to an inner surface of a wrapping portion such that, during use, the foam layer is operably positioned immediately below a user's foot.

In some implementations, a foot chamber support assembly, such as foot chamber support assembly 15000, 16000, includes at least two wrapping wings for extending a wrapping portion of the foot chamber support assembly about the sides and top of the user's foot.

In some implementations, a foot chamber support assembly, such as foot chamber support assembly 15000, 16000, includes at least one wrapping extension for securing the foot chamber support assembly about the heel of the user's foot. In some implementations, the foot chamber support assembly includes at least one wrapping extension for securing the foot chamber support assembly about the toes of the user's foot.

A circulatory-related disorder therapy system, such as compression therapy systems 1000, 3000a, 3000b, can include a compression garment, such as compression garment 16004 or foot chamber support assembly 16000, as described for FIGS. 16A to 16C, along with a CPG device for generating pneumatic pressure for pressurizing one or more independently pressurizable chambers, along with a controller and a controller device. The controller can include one or more processors and is configured to control operation of the CPG device in a therapy process to generate pneumatic pressure in the plurality of chambers of the compression garment during a therapy period. The control device includes one or more processors and a computer readable medium having processor control instructions, that when executed by at least one of the one or more processors of the control device, cause the control device to receive, from the controller, a parameter relating to the therapy process. In some implementations, the controller may be a dedicated standalone controlling device, be part of a flow generator providing the pressurising air or be part of the control device. The standalone control device can be a mobile phone or a tablet computer. In some implementations, the processor control instructions further cause the control device to (i) present a graphical user interface on a display of the control device; (ii) receive, through the graphical user interface, a command from a user, the command being configured, when received, to cause the controller to change the operation of the compression pressure generator in the therapy process; and (iii) transmit, to the controller, the received command. In some implementations, the compression garment further includes one or more valves each pneumatically connected to an air supply channel and to one or more independently pressurizable macro-chambers. The one or more valves supply pressurized air to the one or more independently pressurizable macro-chambers. In some implementations, the controller can further be configured to selectively control operation of the main air supply valve and the plurality of chamber valves.

Various aspects of the described example embodiments may be combined with aspects of certain other example embodiments to realize yet further embodiments. It is to be understood that one or more features of any one example may be combinable with one or more features of the other examples. In addition, any single feature or combination of features in any example or examples may constitute patentable subject matter.

One or more elements or aspects or steps, or any portion(s) thereof, from one or more of any of claims 1 to 44 below can be combined with one or more elements or aspects or steps, or any portion(s) thereof, from one or more of any of the other claims 1 to 44 or combinations thereof, to form one or more additional implementations and/or claims of the present disclosure.

Furthermore, where a value or values are stated herein as being implemented as part of the technology, it is understood that such values may be approximated, unless otherwise stated, and such values may be utilized to any suitable significant digit to the extent that a practical technical implementation may permit or require it.

Unless defined otherwise, all technical and scientific terms used herein have the same meaning as commonly understood by one of ordinary skill in the art to which this technology belongs. Although any methods and materials similar or equivalent to those described herein can also be used in the practice or testing of the present technology, a limited number of the exemplary methods and materials are described herein.

When a particular material is identified as being preferably used to construct a component, obvious alternative materials with similar properties may be used as a substitute. Furthermore, unless specified to the contrary, any and all components herein described are understood to be capable of being manufactured and, as such, may be manufactured together or separately.

It must be noted that as used herein and in the appended claims, the singular forms “a”, “an”, and “the” include their plural equivalents, unless the context clearly dictates otherwise.

All publications mentioned herein are incorporated by reference to disclose and describe the methods and/or materials which are the subject of those publications. The publications discussed herein are provided solely for their disclosure prior to the filing date of the present application. Nothing herein is to be construed as an admission that the present technology is not entitled to antedate such publication by virtue of prior invention. Further, the dates of publication provided may be different from the actual publication dates, which may need to be independently confirmed.

Moreover, in interpreting the disclosure, all terms should be interpreted in the broadest reasonable manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular embodiments, it is to be understood that these embodiments are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilised to distinguish between distinct elements. Furthermore, although process steps in the methodologies may be described or illustrated in an order, such an ordering is not required. Those skilled in the art will recognize that such ordering may be modified and/or aspects thereof may be conducted concurrently or even synchronously.

It is therefore to be understood that numerous modifications may be made to the illustrative embodiments and that other arrangements may be devised without departing from the spirit and scope of the technology.

What is claimed is:

1. A compression garment for implementing circulatory-related disorder therapy, the compression garment comprising:
one or more independently pressurizable macro-chambers, each macro-chamber configured to receive pressurized air;
one or more air supply tubes configured to supply pressurized air to a respective one of the one or more independently pressurized macro-chambers;
one or more tube guides, each tube guide configured to maintain a corresponding one of the one or more air supply tubes on a predetermined pathway in or on the garment; and
one or more valves each pneumatically connected to an air supply tube and to at least one of the one or more independently pressurized macro-chambers, the one or more valves configured to supply pressurized air to one or more independently pressurizable macro-chambers,
wherein the one or more tube guides define predetermined pathways to or from one or more valves, and/or to or from one or more independently pressurized macro-chambers.

2. The compression garment of claim 1, wherein at least one of the one or more tube guides is formed integrally with the compression garment.

3. The compression garment of claim 2, further comprising a layer on an inner side of the compression garment, wherein at least one of the one or more tube guides is formed at least partially by the layer.

4. The compression garment of any one of claims 1 to 3, wherein the one or more tube guides maintain one or more air supply tubes on the predetermined pathway during insertion into the compression garment.

5. The compression garment of any one of claims 1 to 4, wherein the one or more tube guides maintain the corresponding air supply tubes on the predetermined pathway, thereby preventing the air supply tubes from becoming entangled with one another or with other components of the compression garment.

6. The compression garment of any one of claims 1 to 5, further comprising a pocket for housing an air control assembly, the air control assembly being pneumatically coupled with the one or more valves.

7. The compression garment of any one of claims 1 to 6, wherein at least one of (a) the one or more independently pressurized macro-chambers, (b) the one or more of the tube guides, or (c) the pocket is formed between a skin contacting layer and a second layer.

8. The compression garment of any one of claims 6 to 7, wherein the pocket includes at least a portion of one or more of the tube guides.

9. The compression garment of any one of claims 6 to 8, wherein the air control assembly is configured as a pneumatic spine included in the pocket.

10. The compression garment of any one of claims 1 to 9, wherein the one or more valves are in two rows in close proximity to each other.

11. The compression garment of any one of claims 9 to 10, wherein the one or more valves are a part of the pneumatic spine.

12. The compression garment of any one of claims 9 to 11, wherein at least one of the one or more valves is located remotely from the pneumatic spine.

13. The compression garment of any one of claims 9 to 12, wherein two or more of the one or more valves are distributed at multiple dispersed locations of the compression garment.

14. A circulatory-related disorder therapy system comprising:
the compression garment of any one of claims 1 to 13, the compression garment configured to be pressurized by a compression pressure generator; and
a controller, including one or more processors, configured to control operation of the compression pressure generator in a therapy process to generate pneumatic pressure in the one or more independently pressurizable macro-chambers of the compression garment during a therapy period.

15. A circulatory-related disorder therapy system of claim 14, wherein the system is configured to interact with a control device including one or more processors and a computer readable medium having processor control instructions, that when executed by at least one of the one or more processors of the control device, cause the control device to receive, from the controller, a parameter relating to the therapy process.

16. A circulatory-related disorder therapy system of claim 15, wherein the processor control instructions further cause the control device to:
present a graphical user interface on a display of the control device;
receive, through the graphical user interface, a command from a user, the command being configured, when received, to cause the controller to change the operation of the compression pressure generator in the therapy process; and
transmit, to the controller, the received command.

17. A circulatory-related disorder therapy system of any one of claims 14 to 16, wherein the controller is further configured to selectively control operation of the one or more valves.

18. A circulatory-related disorder therapy system of any one of claims 14 to 17, wherein the system further includes at least one of the compression pressure generator and the control device.

19. A compression garment for implementing circulatory-related disorder therapy, the compression garment comprising:
an inner layer;
an outer layer;
an intermediate layer positioned between the inner layer and the outer layer;
one or more independently pressurizable macro-chambers integrally formed between any two layers on the inner layer facing side of the intermediate layer, each macro-chamber configured to receive pressurized air;
one or more air supply channels integrally formed within the garment between any two layers on the outer layer facing side of the intermediate layer, the one or more air supply channels configured to supply pressurized air to a respective one of the one or more independently pressurized macro-chambers; and
one or more valves each pneumatically connected to an air supply channel and to one or more independently pressurizable macro-chambers, the one or more valves configured to supply pressurized air to the one or more independently pressurizable macro-chambers.

20. The compression garment of claim 19, wherein one of the any two layers includes the intermediate layer.

21. The compression garment of any one of claims 19 to 20, wherein one of the any two layers on the inner layer facing side includes the inner layer.

22. The compression garment of any one of claims 19 to 21, wherein one of the any two layers on the outer layer facing side includes the outer layer.

23. The compression garment of claim 19, wherein the compression garment is a three-layer garment including the inner layer, the outer layer, and the intermediate layer; and wherein the one or more independent pressurizable macro-chambers are formed between the inner layer and the intermediate layer, and the one or more air supply channels are integrally formed between the outer layer and the intermediate layer.

24. The compression garment of any one of claims 19 to 23, wherein the independently pressurizable macro-chambers and the air supply channels are formed in the same area of the garment.

25. The compression garment of any one of claims 19 to 24, wherein one or more of the independently pressurizable macro-chambers overlap at least a portion of the one or more of the air supply channels.

26. The compression garment of any one of claims 19 to 25, wherein the one or more air supply channels are formed along seams separating at least two of the one or more independently pressurizable macro-chambers.

27. The compression garment of any one of claims 19 to 26, wherein the any two layers forming an air supply channel include airtight materials.

28. The compression garment of any one of claims 19 to 27, wherein one or more connectors are disposed on the outer layer, each of the one or more connectors being connected to one or more air supply channels.

29. A compression garment for circulatory-related disorder therapy including a foot section configured to wrap at least partially around a user's foot, the compression garment comprising:
a plurality of independently pressurizable chambers including at least one foot-section chamber configured to receive pressurized air; and
a foot chamber support assembly configured to support the at least one foot-section chamber at a user's foot, at least a portion of the foot chamber support assembly being flexible to allow bending around a periphery of the user's foot during use, thereby aiding the foot chamber support assembly to conform to the user's foot.

30. The compression garment of claim 29, wherein the foot chamber support assembly is configured to extend along the entire length of the user's foot, thereby aiding the user in walking while the at least one foot-section chamber of the compression garment is operably positioned on the user's foot.

31. The compression garment of any one of claims 29 to 30, wherein the foot chamber support assembly includes a wrapping portion and a flexible sole coupled to the wrapping portion, the wrapping portion configured to at least partially wrap around the user's foot and secure the foot chamber assembly to the user's foot during use, the flexible sole extending along the entire length of the user's foot.

32. The compression garment of claim 31, wherein, during use, the foot chamber support assembly at least partially wraps around the user's foot during use to secure the foot chamber support assembly to the user's foot, and at least a peripheral portion of the flexible sole bends around the periphery of the user's foot.

33. The compression garment of any one of claims 31 to 32, wherein the bending is in both a horizontal plane defined by the flexible sole and a vertical plane perpendicular to the horizontal plane.

34. The compression garment of any one of claims 31 to 33, wherein the flexible sole includes a flexible outer sole bonded to an underside surface of the foot chamber support assembly, the flexible sole being flexible to allow bending around a periphery of the user's foot during use.

35. The compression garment of claim 34, wherein the flexible outer sole is fabricated from a foam material.

36. The compression garment of any one of claims 29 to 35, wherein the foot chamber support assembly includes a foam layer attached to an inner surface of a wrapping portion such that, during use, the foam layer is operably positioned immediately below a user's foot.

37. The compression garment of any one of claims 29 to 36, wherein the foot chamber support assembly includes at least two wrapping wings for extending a wrapping portion of the foot chamber support assembly about the sides and top of the user's foot.

38. The compression garment of any one of claims 29 to 37, wherein the foot chamber support assembly includes at least one wrapping extension for securing the foot chamber support assembly about the heel of the user's foot.

39. The compression garment of any one of claims 29 to 38, wherein the foot chamber support assembly includes at least one wrapping extension for securing the foot chamber support assembly about the toes of the user's foot.

40. A compression garment for circulatory-related disorder therapy, the compression garment comprising:
a plurality of chambers;
a plurality of chamber valves each configured to supply pressurized air to a corresponding chamber such that the pressurized air can be delivered to each of the plurality of chambers; and
a main air supply valve pneumatically connected to a central air supply line and configured to control the supply of pressurised air to at least two of the plurality of chamber valves, the main air supply valve being located on or in the garment.

41. The compression garment of claim 40, further comprising a chamber air supply line pneumatically connected to the main air supply valve and the plurality of chamber valves, wherein the main air supply valve is configured to turn on and off the supply of pressurized air into the chamber air supply line.

42. The compression garment of any one of claims 40 to 41, wherein the main air supply valve is configured to allow a non-zero flow of pressurised air that is less than the maximum supply of pressurized air into the chamber air supply line.

43. The compression garment of any one of claims 41 to 42, wherein the main air supply valve is configured to control a plurality of different flows of pressurized air into the chamber air supply line.

44. The compression garment of any one of claims 40 to 43, wherein the main air supply valve is pneumatically connected to the chamber air supply line, and wherein the chamber air supply line is pneumatically connected to an exhaust valve, and to each of the plurality of chambers valves, to allow adjustment of the pressure in the plurality of chambers.
